(19) United States
(12) Patent Application Publication
(10) Pub. No.: US 2024/0403648 A1
(43) Pub. Date: Dec. 5, 2024

(54) INFERRING USER ACTIVITIES FROM INTERNET OF THINGS (IOT) CONNECTED DEVICE EVENTS USING MACHINE LEARNING BASED ALGORITHMS

(71) Applicants: Guoliang Xue, Chandler, AZ (US); Yinxin Wan, Tempe, AZ (US); Xuanli Lin, Gilbert, AZ (US); Kuai Xu, Peoria, AZ (US); Feng Wang, Peoria, AZ (US)

(72) Inventors: Guoliang Xue, Chandler, AZ (US); Yinxin Wan, Tempe, AZ (US); Xuanli Lin, Gilbert, AZ (US); Kuai Xu, Peoria, AZ (US); Feng Wang, Peoria, AZ (US)

(73) Assignee: Arizona Board of Regents on Behalf of Arizona State University, Scottsdale, AZ (US)

(21) Appl. No.: 18/734,240

(22) Filed: Jun. 5, 2024

Related U.S. Application Data
(60) Provisional application No. 63/506,316, filed on Jun. 5, 2023.

(51) Int. Cl. G06N 3/088

(52) U.S. Cl. CPC G06N 3/088

(57) ABSTRACT

An Internet-of-Things (IoT) learning framework (IoT learning framework) may train AI models to infer user activities from IoT connected device events using machine learning based algorithms. According to such an example, processing circuitry obtains a training dataset indicating IoT device events and extracts representative user activity patterns from the sequences of IoT device events. In such an example, processing circuitry trains the AI model to learn an optimal subset of the sequences of IoT device events corresponding to a smallest quantity of the sequences of IoT device events to predict user activities with accuracy that satisfies a threshold and outputs the AI model. According to such an example, processing circuitry may obtain new data indicating new sequences of IoT device events and generates output indicating one or more user activities predicted by the AI model to have occurred based on the new sequences of IoT device events.

### CLAIM OF PRIORITY

This application claims the benefit of U.S. Patent Application No. 63/506,316, filed Jun. 5, 2023, the entire contents of which is incorporated herein by reference.

### GOVERNMENT RIGHTS AND GOVERNMENT AGENCY SUPPORT NOTICE

This invention was made with government support under 1717197, 1816995 and 2007469 awarded by the National Science Foundation. The government has certain rights in the invention.

### TECHNICAL FIELD

This disclosure generally relates to the field of artificial intelligence and machine learning via computational systems and more particularly, to systems, methods, and apparatuses for inferring user activities from Internet of Things (IoT) connected device events using machine learning based algorithms.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Machine learning models have various applications to automatically process inputs and produce outputs considering situational factors and learned information to improve output quality. One area where machine learning models, and neural networks in particular, provide high utility is in the field of image processing.

Within the context of machine learning and with regard to deep learning specifically, a Convolutional Neural Network (CNN, or ConvNet) is a class of deep neural networks, very often applied to analyzing visual imagery. Convolutional Neural Networks are regularized versions of multilayer perceptrons. Multilayer perceptrons are fully connected networks, such that each neuron in one layer is connected to all neurons in the next layer, a characteristic which often leads to a problem of overfitting of the data and the need for model regularization. Convolutional Neural Networks also seek to apply model regularization, but with a distinct approach. Specifically, CNNs take advantage of the hierarchical pattern in data and assemble more complex patterns using smaller and simpler patterns. Consequently, on the scale of connectedness and complexity, CNNs are on the lower extreme.

### SUMMARY

In general, this disclosure is directed to improved techniques for inferring user activities from Internet of Things (IoT) connected device events using machine learning based algorithms.

The Internet of Things or “IT” describes physical network connected objects or groups of such objects having sensors, processing capabilities, software, and other computational technologies that connect and exchange data with other devices and systems over the Internet or other communications networks. Commonly, but not necessarily, connected with a public Internet, such IoT devices are individually addressable and very often operate autonomously, without requiring user input once they are provisioned and connected with a network.

The rapid and ubiquitous deployment of Internet of Things (IoT) in smart homes has created unprecedented opportunities to automatically extract environmental knowledge, awareness, and intelligence. Attempts have been made to utilize either machine learning approaches or deterministic approaches to infer IoT device events and/or user activities from network traffic in smart homes.

Described herein are solutions and improved methodologies via which to overcome the difficulties and problems of inferring user activity patterns from a sequence of device events.

Unfortunately, prior known techniques fail to adequately capture, analyze, and provide meaningful predictive output on the basis of available IoT data.

What is needed is an improved technique for using unsupervised learning algorithms which are capable of making inferences that are more adaptive to varying scenarios, such as IoT device malfunctions versus legitimate inferences from user activity.

The present state of the art may therefore benefit from the systems, methods, and apparatuses for inferring user activities from Internet of Things (IoT) connected device events using machine learning based algorithms, as is described herein.

In at least one example, one or more processors of a computing device are configured to perform a computer-implemented method. Such a method may include processing circuitry executing an Internet-of-Things (IoT) learning framework (IoT learning framework) to train an AI model. According to such an example, processing circuitry may obtain, using the IoT learning framework, a training dataset indicating at least sequences of IoT device events and extract representative user activity patterns from the sequences of IoT device events indicated by the training dataset. In such an example, processing circuitry may train, using the IoT learning framework, the AI model to learn an optimal subset of the sequences of IoT device events corresponding to a smallest quantity of the sequences of IoT device events to predict user activities with accuracy that satisfies a threshold. The processing circuitry may output, using the IoT learning framework, the AI model and obtain new data indicating new sequences of IoT device events not indicated by the training dataset. In such an example, processing circuitry may generate, using the AI model, output indicating one or more user activities predicted by the AI model to have occurred based on the new sequences of IoT device events.

In at least one example, a system includes processing circuitry; non-transitory computer readable media; and instructions that, when executed by the processing circuitry, configure the processing circuitry to perform operations. In such an example, processing circuitry may configure the system to execute an Internet-of-Things (IoT) learning framework (IoT learning framework) to train an AI model. According to such an example, processing circuitry may obtain, using the IoT learning framework, a training dataset indicating at least sequences of IoT device events and extract representative user activity patterns from the sequences of IoT device events indicated by the training dataset. In such an example, processing circuitry may train, using the IoT learning framework, the AI model to learn an optimal subset of the sequences of IoT device events corresponding to a smallest quantity of the sequences of IoT device events to predict user activities with accuracy that satisfies a threshold. The processing circuitry may output, using the IoT learning framework, the AI model and obtain new data indicating new sequences of IoT device events not indicated by the training dataset. In such an example, processing circuitry may generate, using the AI model, output indicating one or more user activities predicted by the AI model to have occurred based on the new sequences of IoT device events.

In one example, there is computer-readable storage media having instructions that, when executed, configure processing circuitry to perform operations. Such operations may include executing an Internet-of-Things (IoT) learning framework (IoT learning framework) to train an AI model. According to such an example, processing circuitry may obtain, using the IoT learning framework, a training dataset indicating at least sequences of IoT device events and extract representative user activity patterns from the sequences of IoT device events indicated by the training dataset. In such an example, processing circuitry may train, using the IoT learning framework, the AI model to learn an optimal subset of the sequences of IoT device events corresponding to a smallest quantity of the sequences of IoT device events to predict user activities with accuracy that satisfies a threshold. The processing circuitry may output, using the IT learning framework, the AI model and obtain new data indicating new sequences of IoT device events not indicated by the training dataset. In such an example, processing circuitry may generate, using the AI model, output indicating one or more user activities predicted by the AI model to have occurred based on the new sequences of IoT device events.

The details of one or more examples of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating further details of one example of computing device, in accordance with aspects of the disclosure.

FIG. 2 depicts an example architecture of the Internet of Things (IoT), each being connected with a network, such as a public Internet, in accordance with aspects of the disclosure.

FIGS. 3A, 3B, and 3C set forth Table 1 providing a listing of commonly used notations used in accordance with aspects of the disclosure.

FIGS. 4A and 4B set forth Algorithm 1 depicting an example implementation of the AkMatch functionality for computing the minimal and the lightest amongst the available matches, in accordance with aspects of the disclosure.

FIG. 5 sets forth Table 2 depicting an example graphical illustration of the AkMatch functionality, in accordance with aspects of the disclosure.

FIG. 6 sets forth Algorithm 2 depicting an example implementation of the OMatch ( [symbol] ,w) functionality for computing a compatible sub-sequence of user activity patterns, in accordance with aspects of the disclosure.

FIGS. 7A, 7B, and 7C set forth Algorithm 3 depicting an example implementation of the SLN-1D functionality for computing an optimal solution to the 1-D problem, in accordance with aspects of the disclosure.

FIG. 8 sets forth Algorithm 4 depicting an example implementation of the SLN-ND functionality for applying a round-robin coordinate descent approach as part of solving an optimization problem, in accordance with aspects of the disclosure.

FIG. 9 depicts a chart of the various performances of E2AP and IoTMosaic on synth/synth-MF test cases, in accordance with aspects of the disclosure.

FIGS. 10A and 10B set forth Table 3A depicting results on real data, with one case per row and further depicting synthetic data as an average over 100 cases per row, in accordance with aspects of the disclosure.

FIG. 11 is a flow chart illustrating an example mode of operation for the computing device to infer user activities from Internet of Things (IoT) connected device events using machine learning based algorithms, in accordance with aspects of the disclosure.

Like reference characters denote like elements throughout the text and figures.

### DETAILED DESCRIPTION

Aspects of the disclosure provide improved techniques for inferring user activities from Internet of Things (IoT) connected device events using machine learning based algorithms.

The Internet of Things or “IoT” describes physical network connected objects or groups of such objects having sensors, processing capabilities, software, and other computational technologies that connect and exchange data with other devices and systems over the Internet or other communications networks. Commonly, but not necessarily, connected with a public Internet, such IoT devices are individually addressable and very often operate autonomously, without requiring user input once they are provisioned and connected with a network.

The rapid and ubiquitous deployment of Internet of Things (IoT) in smart homes has created unprecedented opportunities to automatically extract environmental knowledge, awareness, and intelligence. Attempts have been made to utilize either machine learning approaches or deterministic approaches to infer IoT device events and/or user activities from network traffic in smart homes.

Described herein are solutions and improved methodologies via which to overcome the difficulties and problems of inferring user activity patterns from a sequence of device events. For instance, example techniques set forth herein operate by first deterministically extracting a small number of representative user activity patterns from the sequence of device events, then applying unsupervised learning to compute an optimal subset of these user activity patterns to infer user activities. Based on extensive experiments with sequences of device events triggered by 2,959 real user activities and up to 30,000 synthetic user activities, experimental results demonstrate that the disclosed scheme is resilient to device malfunctions and transient failures/delays, and outperforms all prior known state-of-the-art solutions.

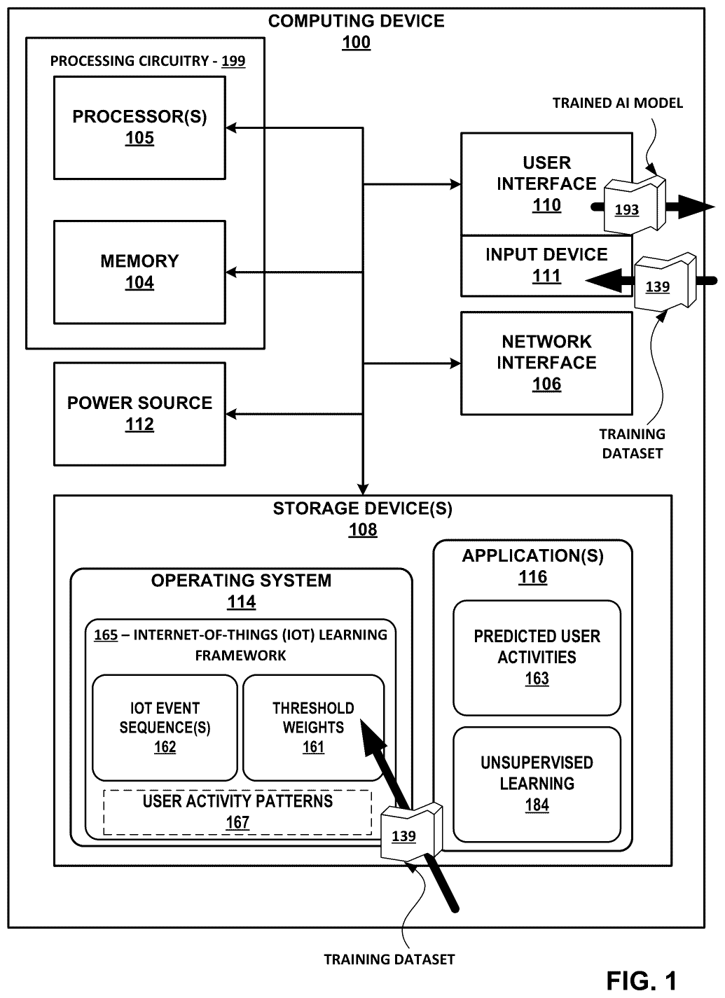

FIG. 1 is a block diagram illustrating further details of one example of computing device, in accordance with aspects of the disclosure. FIG. 1 illustrates only one particular example of computing device 100. Many other examples of computing device 100 may be used in other instances.

As shown in the specific example of FIG. 1, computing device 100 may include processing circuitry 199 including one or more processors 105 and memory 104. Computing device 100 may further include network interface 106, one or more storage devices 108, user interface 110, and power source 112. Computing device 100 may also include an operating system 114. Computing device 100, in one example, may further include one or more applications 116, such as predicted user activities 163 and unsupervised learning 184. One or more other applications 116 may also be executable by computing device 100. Components of computing device 100 may be interconnected (physically, communicatively, and/or operatively) for inter-component communications.

Operating system 114 may execute various functions including executing trained AI model 193 and performing AI model training. As shown here, operating system 114 executes an Internet-of-Things (IoT) learning framework 165 (IoT learning framework 165 hereinafter) which includes both IoT event sequences 161 and threshold weights 162 by which to configure and adjust learning and predictive characteristics of AI model 193 trained via IoT learning framework 165. Threshold weights 162 may receive as input, a training dataset 139 upon which network weights utilized by IoT learning framework 165 may be adjusted or generated. IoT learning framework 165 further includes user activity patterns 167 which may be derived or predicted by IoT learning framework 165 utilizing learnings derived from training dataset 139.

Computing device 100 may perform techniques for inferring user activities from Internet of Things (IoT) connected device events using machine learning based algorithms, including performing AI model 193 training using training dataset 139 including, for example, learning techniques for solving the E2AP and E2A problems and determining weights for the patterns using unsupervised learning. IoT learning framework 165 may train and generate as output, trained AI model 193. Computing device 100 may provide trained AI model 193 as output to a connected user device via user interface 110.

In some examples, processing circuitry including one or more processors 105, implements functionality and/or process instructions for execution within computing device 100. For example, one or more processors 105 may be capable of processing instructions stored in memory 104 and/or instructions stored on one or more storage devices 108.

Memory 104, in one example, may store information within computing device 100 during operation. Memory 104, in some examples, may represent a computer-readable storage medium. In some examples, memory 104 may be a temporary memory, meaning that a primary purpose of memory 104 may not be long-term storage. Memory 104, in some examples, may be described as a volatile memory, meaning that memory 104 may not maintain stored contents when computing device 100 is turned off. Examples of volatile memories may include random access memories (RAM), dynamic random-access memories (DRAM), static random-access memories (SRAM), and other forms of volatile memories. In some examples, memory 104 may be used to store program instructions for execution by one or more processors 105. Memory 104, in one example, may be used by software or applications running on computing device 100 (e.g., one or more applications 116) to temporarily store data and/or instructions during program execution.

One or more storage devices 108, in some examples, may also include one or more computer-readable storage media. One or more storage devices 108 may be configured to store larger amounts of information than memory 104. One or more storage devices 108 may further be configured for long-term storage of information. In some examples, one or more storage devices 108 may include non-volatile storage elements. Examples of such non-volatile storage elements may include magnetic hard disks, optical discs, floppy disks, Flash memories, or forms of electrically programmable memories (EPROM) or electrically erasable and programmable (EEPROM) memories.

Computing device 100, in some examples, may also include a network interface 106. Computing device 100, in such examples, may use network interface 106 to communicate with external devices via one or more networks, such as one or more wired or wireless networks. Network interface 106 may be a network interface card, such as an Ethernet card, an optical transceiver, a radio frequency transceiver, a cellular transceiver or cellular radio, or any other type of device that may send and receive information. Other examples of such network interfaces may include BLUETOOTH®, 3G, 4G, 1G, LTE, and WI-FI® radios in mobile computing devices as well as USB. In some examples, computing device 100 may use network interface 106 to wirelessly communicate with an external device such as a server, mobile phone, or other networked computing device.

User interface 110 may include one or more input devices 111, such as a touch-sensitive display. Input device 111, in some examples, may be configured to receive input from a user through tactile, electromagnetic, audio, and/or video feedback. Examples of input device 111 may include a touch-sensitive display, mouse, keyboard, voice responsive system, video camera, microphone or any other type of device for detecting gestures by a user. In some examples, a touch-sensitive display may include a presence-sensitive screen.

User interface 110 may also include one or more output devices, such as a display screen of a computing device or a touch-sensitive display, including a touch-sensitive display of a mobile computing device. One or more output devices, in some examples, may be configured to provide output to a user using tactile, audio, or video stimuli. One or more output devices, in one example, may include a display, sound card, a video graphics adapter card, or any other type of device for converting a signal into an appropriate form understandable to humans or machines. Additional examples of one or more output devices may include a speaker, a cathode ray tube (CRT) monitor, a liquid crystal display (LCD), or any other type of device that may generate intelligible output to a user.

Computing device 100, in some examples, may include power source 112, which may be rechargeable and provide power to computing device 100. Power source 112, in some examples, may be a battery made from nickel-cadmium, lithium-ion, or other suitable material.

Examples of computing device 100 may include operating system 114. Operating system 114 may be stored in one or more storage devices 108 and may control the operation of components of computing device 100. For example, operating system 114 may facilitate the interaction of one or more applications 116 with hardware components of computing device 100.

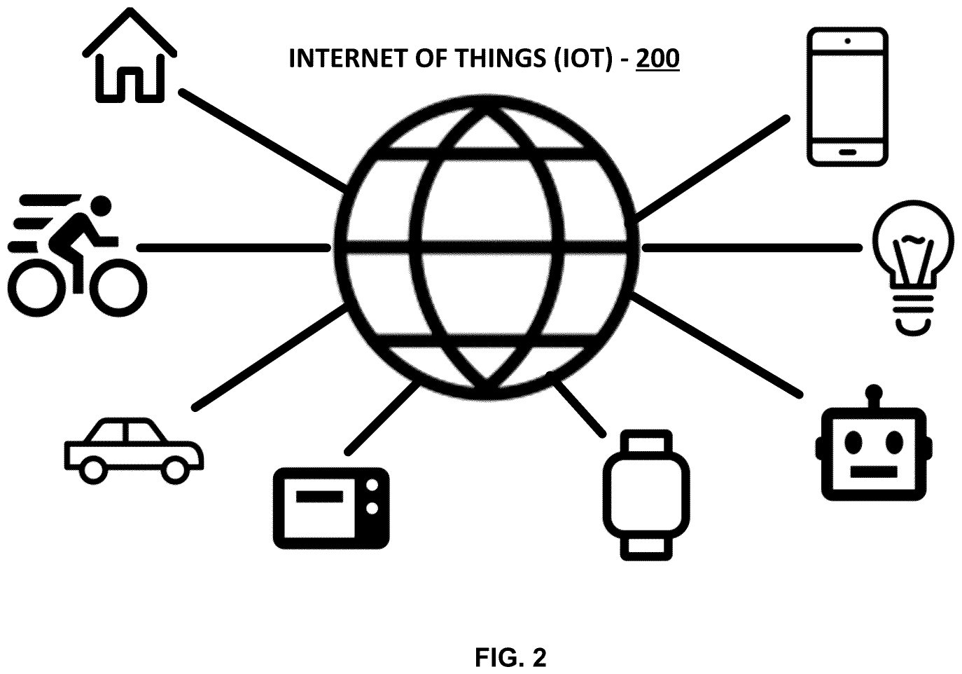

FIG. 2 depicts an example architecture of the Internet of Things (IoT) 200, each being connected with a network, such as a public Internet, in accordance with aspects of the disclosure.

The ubiquitous and heterogeneous deployment of Internet of Things (IoT) devices in smart homes has created new opportunities to extract knowledge, awareness, and intelligence via monitoring and understanding interactions of the devices with their environments and users. A number of studies focused on discovering meaningful information from network traffic of IoT devices in smart homes, even though much of the traffic is often encrypted over secure wireless networks or via IoT application-level encryption.

For example, prior techniques have attempted to use machine learning (ML) models to infer device events from network packets, albeit with limited success. Example models PingPong and IoTAthena models utilized deterministic algorithms for device event extraction based on the observation that every device event generates a repeatable sequence of network packets. Other studies have explored the feasibility of inferring user activities with IoT devices in smart homes. For example, one such technique utilized an unsupervised learning method to discover user activities based on information collected by sensors deployed in a smart home. One study demonstrated the possibility of passively sniffing wireless-only network traffic of IoT devices for detecting and identifying IoT device types and user activities in smart homes from an adversary perspective. Still further, User Activity Inference (UAI) and an approximate matching-based algorithm has been explored to infer a multi-set of user activities from the network traffic of IoT devices, which was actively collected at programmable home routers from a trusted home user perspective.

However, reconstructing real-world user activities in smart homes and matching them with the ground-truth requires an exact sequence of user activities, rather than a multi-set of user activities produced by IoTMosaic.

Towards this end, the problems of Events to Activities (E2A) and Events to Activity Patterns (E2AP) were studied from a trusted home user perspective for inferring a sequence of user activities from a sequence of IoT device events, which can be extracted from network traffic using existing methods such as PingPong and IoTAthena. A two-phase scheme was specially designed and configured employing both deterministic algorithms and machine learning techniques for solving the E2AP and E2A problems.

In Phase 1, a small number of representative matches of the activity patterns is computed. It is proven that the solution computed based on these representative matches is as good as any solution that can be obtained by considering all possible matches. In Phase 2, an efficient algorithm is described for computing a compatible set of matches of user activity patterns with maximum total weight, for any given weight assignment to the matches.

An unsupervised learning algorithm was also designed and configured for computing a good set of weights. While the loss function for the problem is non-differentiable, an exact algorithm was specifically designed for minimizing the loss function over any one of the weight variables. Similar to many ML algorithms that build optimization models and learn optimal parameters, the implementation described herein utilizes a coordinate descent algorithm designed for solving E2AP which converges in a finite number of iterations.

Therefore, practice of the described techniques provides at least the following benefits: Firstly, the problem of inferring a sequence of user activities and their patterns in smart homes is formulated from a sequence of device events extracted from network traffic. Secondly, it is proven that one can concentrate on a small number of representative matches of user activity patterns and design an efficient algorithm for computing these representatives. Thirdly, an efficient algorithm described herein was designed and implemented to compute a compatible set of matches of user activity patterns with maximum total weight for any given weight assignment. A complementary algorithm was then designed and implemented to compute an optimal set of weights in a finite number of iterations via unsupervised learning. Fourthly, extensive experiments were conducted with both real and synthetic data and demonstrate that the algorithm is robust and outperforms the state-of-the-art solution.

### Problem Formulation and Basics:

Research suggests that a user activity in a smart home may be inferred from the sequence of IoT device events triggered by the activity. For example, one of the user activities studied in attempts indicates that: “[a] person without [a] key entering the home from the front door during the day” usually triggers the sequence of 10 IoT device events, including: Ring doorbell motion detection, Ring spotlight motion detection, Ring doorbell ringing, Ring doorbell stream on, Ring doorbell stream off, August lock manual unlocking, Tessan contact sensor open, Tessan contact sensor close, August lock manual locking, Arlo Q camera motion detection, collectively involving 5 devices.

Intuitively, observing this sequence of 10 device events in a very short period of time suggests that the above user activity very likely has happened. If a device malfunctions when a user activity occurs, the device events corresponding to this device will be missing from the sequence. For example, if the Tessan contact sensor malfunctions, the events Tessan contact sensor open and Tessan contact sensor close will be missing in the corresponding sequence of device events. If the Ring doorbell is in sleeping mode when the user activity occurs, the event Ring doorbell motion detection will be delayed. Because the amount of delay varies significantly in the experiments, device events were thus considered to be missing as well.

The experiments use [symbol] ={A¹, A², . . . , [symbol] } of user activities. Each occurrence of a user activity A∈ [symbol] triggers a sequence of IoT device events

$${𝕊}^{1} ( A ) = ( {e}_{1}^{A , 1} , {e}_{2}^{A , 1} , … , {e}_{\vert {𝕊}^{1} ( A ) \vert}^{A , 1} )$$

or a subsequence of [symbol] (A), where the missing events correspond to devices that malfunction when A occurs. The experiments set use | [symbol] | to denote the cardinality of set A and use | [symbol] | to denote the length of sequence [symbol] . The experiments set use [symbol] =(A₁, A₂, . . . , [symbol] ) to denote a sequence of user activities. The examples provided use superscripts in the description of (distinct) user activities in set [symbol] , and use subscripts in the description of (not necessarily distinct) user activities in sequence [symbol] . The terms A¹ and A² denote two distinct elements in set A. The terms A₁ and A₂ denote the first and second elements in sequence [symbol] , respectively.

For a user activity A, the examples use [symbol] (A)={ [symbol] (A), [symbol] (A), . . . , [symbol] (A)} to denote the set of distinct sequences of device events that could be triggered by A, where

$${𝕊}^{k} ( A ) = ( {e}_{1}^{A , k} , {e}_{2}^{A , k} , … , {e}_{\vert {𝕊}^{k} ( A ) \vert}^{A , k} )$$

for k=1, 2, . . . , |S(A)|, and [symbol] (A) is a subsequence of [symbol] (A) for k>1. The examples call [symbol] (A) the set of possible patterns of A. In the experiments, [symbol] (A) is extracted through observing the device event sequences triggered by repeated occurrences of A.

Each IoT device may correspond to multiple events. Each user may correspond to multiple user activities, and two different user activities may both involve a common device event. IoT learning framework 165 may focus AI model training on user activities (rather than users) and device events (rather than devices). Several examples are used to illustrate important concepts and algorithms. For ease of understanding, the following settings were utilized for all examples.

Example Setting: [symbol] =(a, b, a, b, d, c, a, b, c) is the sequence of device events. [symbol] ={A¹, A²} is the set of user activities. The set of possible patterns for A¹ (A², respectively) is [symbol] (A¹)={(a, b)}( [symbol] (A²)={(a, b, c), (a, b)}.

The sequence of device events triggered by a sequence [symbol] of user activities, denoted by E( [symbol] ), satisfies Equation 1, set forth below, as follows:

$$E ( 𝔸 ) ∈ \{ {Z}_{1} ‖ {Z}_{2} ‖ … ‖ {Z}_{\vert 𝔸 \vert} \vert {Z}_{j} ∈ ( {A}_{j} ) , ∀ j = 1 , … , \vert 𝔸 \vert \} .$$

Example 1: Let [symbol] =(A¹, A², A²) and [symbol] =(A², A², A²) be two sequences of user activities, where A¹ and A² are as in the example setting. Then E( [symbol] ) could be any of (a, b, a, b, c, a, b, c), (a, b, a, b, c, a, b), (a, b, a, b, a, b, c), or (a, b, a, b, a, b). Similarly, E( [symbol] ) could be any of (a, b, c, a, b, c, a, b, c), (a, b, c, a, b, c, a, b), (a, b, c, a, b, a, b, c), (a, b, c, a, b, a, b), (a, b, a, b, c, a, b, c), (a, b, a, b, c, a, b), (a, b, a, b, a, b, c), or (a, b, a, b, a, b).

This example shows that the same sequence of user activities may trigger different sequences of device events, while different sequences of user activities may trigger the same sequence of device events. The nondeterministic mapping E maps a sequence of user activities to a sequence of device events. Also of interest is the reverse problem, specifically: inferring the sequence of user activities from a given sequence of IoT device events. This is called the E2A problem (Events to Activities), defined in the following.

Problem 1 (E2A): Let [symbol] ={A¹, A², . . . , [symbol] } be a set of user activities. For each A∈ [symbol] , its set of possible patterns [symbol] (A) is known. Given a sequence of IoT device events [symbol] =(e₁, e₂, . . . , eₘ), the E2A problem seeks for a sequence [symbol] =(A¹, A², . . . , [symbol] ) of user activities in A that is most likely to trigger the sequence of device events [symbol] .

Further described herein is the Events to Activity Patterns problem (E2AP) to infer a sequence of user activities together with their patterns. The solution to this problem can be used to provide accurate quantification of the solution quality.

Problem 2 (E2AP): Let [symbol] ={A¹, A², . . . , [symbol] } be a set of user activities. For each A∈ [symbol] A∈A, its set of possible patterns [symbol] (A) is known. Given a sequence of IoT device events [symbol] =(e₁, e₂, . . . , eₘ), the E2AP problem seeks for a sequence [symbol] =(A₁, A₂, . . . , [symbol] ) of user activities in A together with pattern [symbol] ∈ [symbol] (Aⱼ) for j=1, 2, . . . , | [symbol] |, such that [symbol] ∥ [symbol] ∥ . . . ∥ [symbol] is as close to as possible.

A solution to the E2AP problem consists of a sequence [symbol] =(A₁, A₂, . . . , [symbol] ) of user activities and a corresponding sequence [symbol] =( [symbol] , [symbol] , . . . , [symbol] ) of activity patterns. One can use [symbol] as a solution to the E2A problem. The edit distance between [symbol] and [symbol] ∥ [symbol] ∥ . . . ∥ [symbol] can be used as a metric to quantify the solution quality.

The E2AP problem is closely related to the UAI problem. With the goal of inferring user activities in a smart home being a known problem, the specific goals and techniques used by the methodologies described herein are different from any prior known technique.

Prior solutions to UAI produce a multi-set of user activities; whereas E2AP produces a sequence of user activity patterns. Note that one may use a sequence of user activity patterns to produce a sequence of user activities which in turn can be used to produce a multi-set of user activities, but not vice versa. A sequence of user activity patterns can be directly compared with the sequence of device events to measure the quality of a solution for E2AP. Such comparison is not possible if the output is a multi-set or a sequence of user activities (without the patterns).

In UAI solutions, each user activity A∈ [symbol] has one signature, which is the full sequence of device events that may be triggered by A (corresponding to [symbol] (A) as used herein), but note that it may trigger a subsequence of the signature. When computing the matching of a signature, prior attempts relied on k-approximate subsequence matching, and gave high priorities to the full sequence of the signature over a partial sequence. In E2AP, all possible signature patterns are considered independently, and the described implementation decides the weights for the patterns using unsupervised learning, where the aim is to minimize the edit distance between the given sequence of device events and the concatenation of the sequence of computed activity patterns. This makes the ML-based scheme resilient to device malfunctions and transient failures/delays, a significant advantage over prior known algorithms.

A two-phase scheme for solving E2AP was therefore designed and implemented.

Phase 1 computes a small number of representative matches in E for each possible pattern [symbol] (Aⁱ) of each user activity Aᵢ∈ [symbol] . It is proven that the solution computed based on the small number of representative matches is as good as any solution that can be obtained by considering all matches. Phase 2 consists of Phase 2A and Phase 2B. Phase 2A computes a compatible sequence [symbol] of representative matches of user activity patterns with maximum total weight, for any given weight assignment w of the matches. The edit distance between [symbol] and the concatenation of the user activity patterns in [symbol] is the value of the loss function ƒ(w). Phase 2B aims to compute an optimal weight w via unsupervised learning. Both Phase 1 and Phase 2B are executed once. Phase 2A is executed multiple times, one for each evaluation of ƒ(w) within Phase 2B.

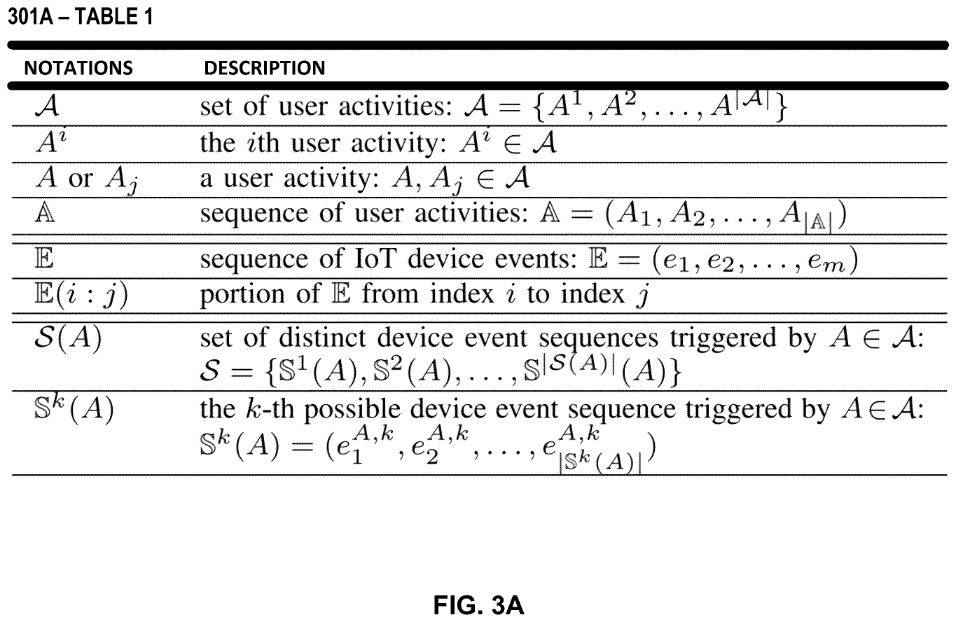

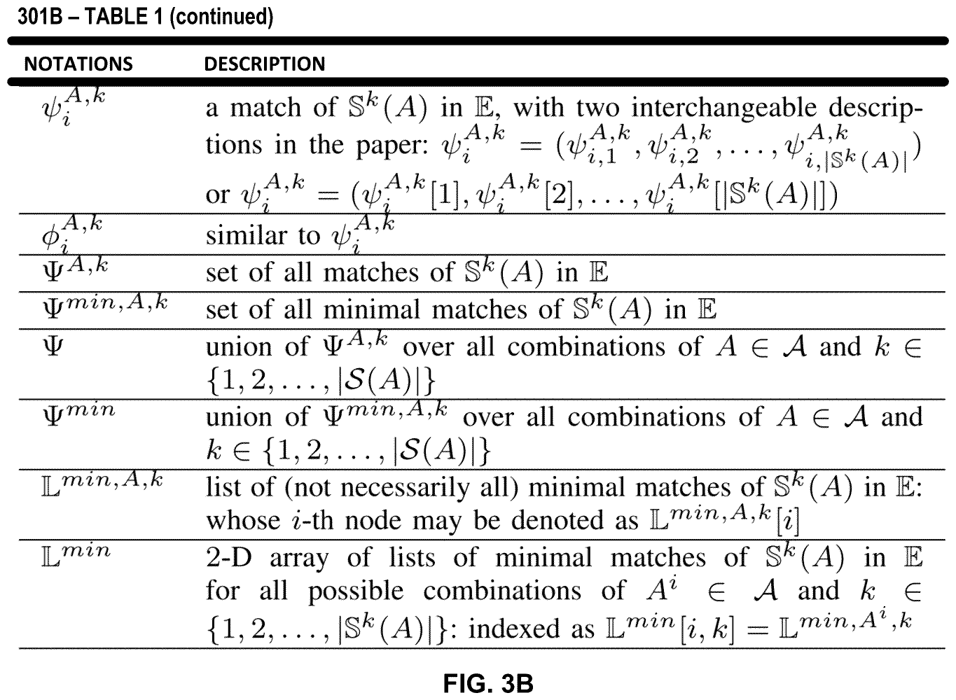

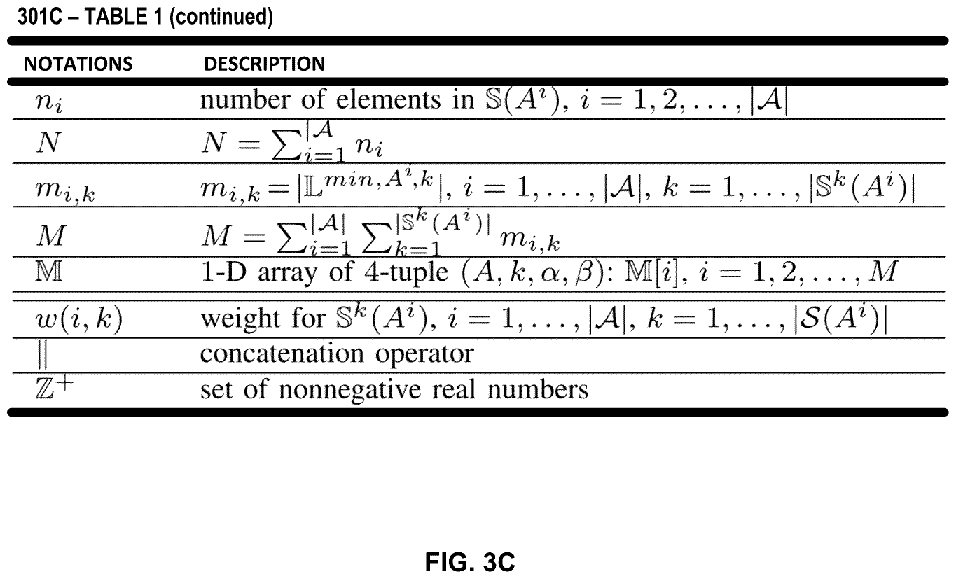

FIGS. 3A, 3B, and 3C set forth Table 1 at elements 301A, 301B, and 301C, respectively, providing a listing of commonly used notations used in accordance with aspects of the disclosure.

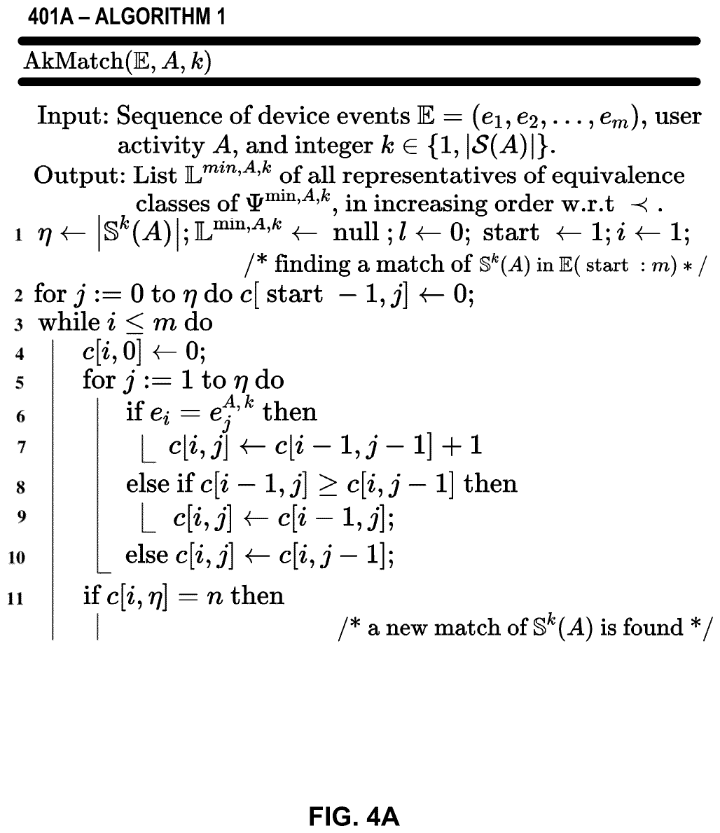

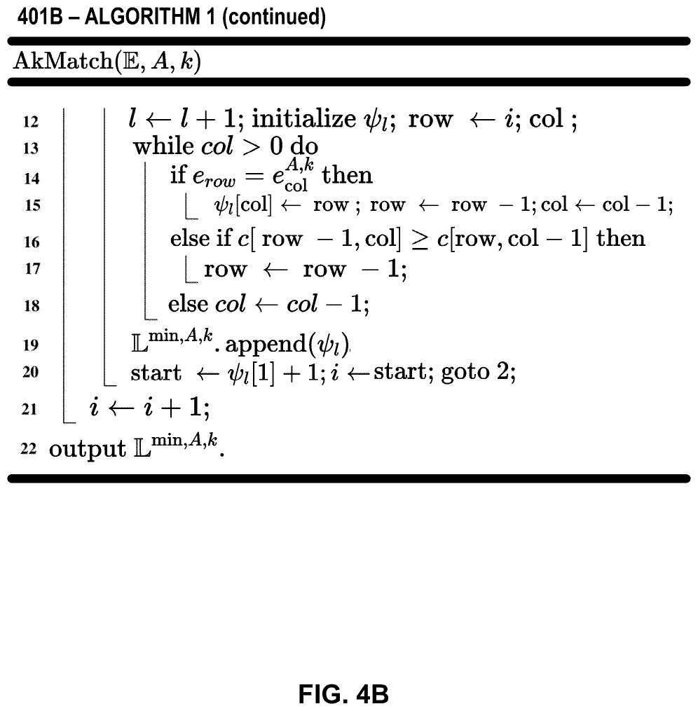

FIGS. 4A and 4B set forth Algorithm 1 at element 401A and 401B, respectively, depicting an example implementation of the AkMatch functionality for computing the minimal and the lightest amongst the available matches, in accordance with aspects of the disclosure.

Matching of a possible activity pattern in the sequence of device events provides a powerful capability as described below.

Definition 1 (match and minimal match): Let [symbol] =(e₁, e₂, . . . , eₘ) be the sequence of device events. Let A∈ [symbol] be a user activity with [symbol] (A)={ [symbol] (A), [symbol] (A), . . . , [symbol] (A)} as its set of possible patterns, where for

$${𝕊}^{k} ( A ) = ( {e}_{1}^{A , k} , {e}_{2}^{A , k} , … , {e}_{\vert {𝕊}^{k} ( A ) \vert}^{A , k} )$$

k=1, 2, . . . , | [symbol] (A)|.

A match of [symbol] (A) in [symbol] , denoted by ψᵢ^{Ak}, i∈ [symbol] , is a sequence of positive integers

$$( {ψ}_{i , 1}^{A , k} , {ψ}_{i , 2}^{A , k} , … , {ψ}_{i , \vert {𝕊}^{k} ( A ) \vert}^{A , k} ) ,$$

according to Equation 2, set forth below as follows:

$$1 \leq {ψ}_{i , j}^{A , k} < {ψ}_{i , {j}^{′}}^{A , k} \leq m , ∀ 1 \leq j < {j}^{′} \leq \vert {𝕊}^{k} ( A ) \vert ,$$

and further according to Equation 3, set forth below, as follows:

$${e}_{{ψ}_{i , k}^{A , k}} = {e}_{j}^{A , k} , ∀ 1 \leq j \leq \vert {𝕊}^{k} ( A ) \vert .$$

The term

$$[ {ψ}_{i , 1}^{A , k} , {ψ}_{i , \vert {𝕊}^{k} ( A ) \vert}^{A , k} ]$$

represents the interval of ψᵢ^{A,k}, denoted as ψᵢ^{A,k}.interval. The term Ψ^{A,k} is used to denote the set of all matches of [symbol] (A) in [symbol] . A match ψᵢ^{A,k} of [symbol] (A) in [symbol] is called minimal, if there is no match ψ_{i′}^{A,k} of [symbol] (A) in [symbol] whose interval is a proper subset of the interval of ψᵢ^{A,k}. The term Ψ^{min,A,k} denotes the set of all minimal matches of [symbol] (A) in [symbol] .

Example 2: Set A to A² in the example setting. Then [symbol] (A)=(a, b, c) has 9 matches in [symbol] : ψ₁^{A,1}=(1,2,6) ψ₂^{A,1}=(1,2,9), ψ₃^{A,1}=(1,4,6), ψ₄^{A,1}=(1,4,9), ψ₅^{A,1}=(1, 8, 9), ψ₆^{A,1}=(3,4,6), (1,8,9), ψ₆^{A,1}=(3,4,6), ψ₇^{A,1}=(3,4,9), ψ₈^{A,1}=(3,8,9) ψ₉^{A,1}=(7,8,9). Among the 9 matches in Ψ^{A,1}, ψ₁^{A,1}, ψ₃^{A,1}, ψ₆^{A,1}, ψ₉^{A,1} are minimal. [symbol] (A) has 6 matches in [symbol] : ψ₁^{A,2}=(1,2), ψ₂^{A,2}=(1,4), ψ₃^{A,2}=(1,8), ψ₄^{A,2}=(3,4), ψ₅^{A,2}=(3,8), ψ₆^{A,2}=(7,8). ψ₁^{A,2}, ψ₄^{A,2}, ψ₆^{A,2} are minimal.

In order to design efficient algorithms for solving the E2AP problem, attention is restricted to O(m) matches of [symbol] (A) in [symbol] for each A and k, without losing important information. To achieve this goal, following concepts and solutions are provided.

Definition 2: (precedence relation on Ψ^{A,k}): A binary relation [symbol] on Ψ^{A,k} is defined as follows. Let ψᵢ^{A,k} and ψ_{i′}^{A,k} be two elements in Ψ^{A,k}. The term ψᵢ^{A,k} [symbol] ψ_{i′}^{A,k} is true when either

$$( {ψ}_{i , \vert {𝕊}^{k} ( A ) \vert}^{A , k} < {ψ}_{{i}^{′} , \vert {𝕊}^{k} ( A ) \vert}^{A , k} ; or {ψ}_{i , \vert {𝕊}^{k} ( A ) \vert}^{A , k} = {ψ}_{{i}^{′} , \vert {𝕊}^{k} ( A ) \vert}^{A , k} and \qquad ( i )$$

$$( {ψ}_{i , \vert {𝕊}^{k} ( A ) \vert - 1}^{A , k} , {ψ}_{i , \vert {𝕊}^{k} ( A ) \vert - 2}^{A , k} … {ψ}_{i , 1}^{A , k} ) \qquad ( ii )$$

is lexicographically greater than or equal to

$$( {ψ}_{{i}^{′} , \vert {𝕊}^{k} ( A ) \vert - 1}^{A , k} , {ψ}_{{i}^{′} , \vert {𝕊}^{k} ( A ) \vert - 2}^{A , k} … , {ψ}_{{i}^{′} , 1}^{A , k} ) .$$

When ℠ [symbol] ψ and ϕ≠ψ, the solutions states that ϕ precedes ψ, denoted by ϕ [symbol] ψ. The solutions states that ϕ is lighter than ψ when ϕ [symbol] ψ. One can verify that [symbol] defined above is a linear ordering on Ψ^{A,k} (as well as on Ψ^{min,A,k}). In other words, the solutions states that:
1) For any ϕ, ψ∈Ψ^{A,k}, at least one in {ϕ [symbol] ψ, ψ [symbol] ϕ} is true.
2) If ϕ [symbol] ψ and ψ [symbol] ϕ, then ϕ=ψ.
3) If ϕ [symbol] ψ and ψ [symbol] γ, then ϕ [symbol] γ.

Definition 3: (equivalence relation on Ψ^{A,k} and Ψ^{min,A,k}): Let A∈ [symbol] , and [symbol] (A) be a possible pattern of A. Let ψᵢ^{A,k} and ψ_{i′}^{A,k}, be two elements in Ψ^{A,k} (Ψ^{min,A,k}, respectively).

The solutions states that ψᵢ^{A,k} is equivalent to ψ_{i′}^{A,k}, denoted by Ψ^{A,k}≡ψ_{i′}^{A,k}, if the intervals of ψᵢ^{A,k} and ψ_{i′}^{A,k} are the same.

Clearly, ≡ is a binary relation defined on Ψ^{A,k}, as well as a binary relation defined on Ψ^{min,A,k}. One can verify that the binary relation≡defined on Ψ^{A,k} (Ψ^{min,A,k}, respectively) is an equivalence relation. This equivalence relation partitions the set Ψ^{A,k} (Ψ^{min,A,k} respectively) into equivalence classes where two matches in Ψ^{A,k} (Ψ^{min,A,k}, respectively) are in the same equivalence class if and only if they are equivalent.

Definition 4 (representative matches): Let A∈ [symbol] , and [symbol] (A) be a possible pattern of A. For each equivalence class of Ψ^{A,k} (Ψ^{min,A,k}, respectively), the implementation chooses the lightest element in the class as its representative.

Example 3: Set A to A² in the example setting. There are 9 members in Ψ^{A,1}. In lexicographical order, they are (1, 2, 6), (1, 2, 9), (1, 4, 6), (1, 4, 9), (1, 8, 9), (3, 4, 6), (3, 4, 9), (3, 8, 9), (7, 8, 9). In lightest first order, there are (3, 4, 6)<(1, 4, 6)<(1, 2, 6)<(7, 8, 9)<(3, 8, 9)<(1, 8, 9)<(3, 4, 9)<(1, 4, 9)<(1, 2, 9).

The 5 equivalence classes of Ψ^{A,1}, with the representative of each class listed first in bold font, are {(3, 4, 6)}, {(1, 4, 6), (1, 2, 6)}, {(7, 8, 9)}, {(3, 8, 9), (3, 4, 9)}, and {(1, 8, 9), (1, 4, 9), (1, 2, 9)}. The 2 equivalence classes of Ψ^{min,A,1} are {(3, 4, 6)} and {(7, 8, 9)}.

In Example 3, each equivalence class of Ψ^{min,A,k} has only one match. In general, the number of elements in an equivalence class of Ψ^{min,A,k} (Ψ^{A,k}) may be very large.

Lemma 1: Let A∈ [symbol] , and [symbol] (A) be a possible pattern of A. The number of equivalence classes of Ψ^{A,k} is no more than m (m+1)/2. The number of equivalence classes of Ψ^{min,A,k} is no more than m, where m=| [symbol] |.

Proof of Lemma 1: By Definition 3, two matches of [symbol] (A) in [symbol] are equivalent if and only if their intervals are the same. Each interval may be represented in the form [α,β] where α and β are integers such that 1≤α≤β≤m. The number of such intervals is m(m+1)/2. This proves the upper-bound on the number of equivalence classes of Ψ^{A,k}.

Let ψᵢ^{min,A,k} and ψ_{i′}^{min}, A, k be two non-equivalent elements of Ψ^{min}, A, k. Let [α,β] and [α′,β′] be the intervals of ψᵢ^{min,A,k} and ψ_{i′}^{min}, A, k, respectively. It is asserted that α≠α′. Suppose to the contrary that α=α′. If β=β′, one may thus conclude that ψᵢ^{min}, A, k≡ψ_{i′}^{min}, A, k; If β<β′, one may conclude that ψᵢ^{min}, A, k is not minimal; If β>β′, one may conclude that ψᵢ^{min}, A, k is not minimal. Therefore, it is proven that α≠α′. This fact implies that the number of equivalence classes of Ψ^{min,A,k} is upper-bounded by m.

### Computing Representative Matches (Phase 1):

Described here is Phase 1 of the two-phase scheme as outlined in above. First presented is Algorithm 1 which may be used to compute a sequence [symbol] _{min,A,k} of the representatives for the equivalence classes of Ψ^{min,A,k}, for any given A∈A, and any k∈{0, 1, . . . , |S(A)|.

The data structures used in Algorithm 1 are as follows:

The term c[ ] is an integer-valued 2-D array of m+1 rows and | [symbol] (A)|+1 columns. The entry c[i,j], when computed, is equal to |LCS ( [symbol] (start:i), [symbol] (A)(1:j))|.

Here LCS(X,Y) denotes a longest common subsequence of X and Y, and |Z| denotes the length of sequence Z.

Integer l is used to index the next match ψₗ∈Ψ^{min,A,k} found. At the end of the algorithm, l is the number of equivalence classes of Ψ^{min,A,k}.

[symbol] is a singly linked list, each node of which is an array of | [symbol] (A)| integers, corresponding to the | [symbol] (A)| indices of a match in Ψ^{min,A,k}. The operation [symbol] append appends a new node/match at the end.

The following is the flow of Algorithm 1:

Lines 1 and 4 perform initialization. In particular, begin by initializing c[start−1, j] to 0, which is |LCS (null, [symbol] (A)(1:j))| for all j and all start. Also, initialize c[i, 0] to 0, which is |LCS ( [symbol] (start:i), null)| for all i and all start.

In Line 1, Both start and i are set to 1 to get ready to compute the lightest minimal match of [symbol] (A) in [symbol] among those whose interval is contained in [start,m]. Line 20 also sets new values of start and i before control goes to Line 2 to start the computation of the next match in Ψ^{min,A,k}.

In consecutive executions of the while loop in Line 3 with the same start value, the aim is to compute the lightest minimal match of [symbol] (A) in E among those whose intervals are contained in [start,m], for the corresponding start value. Note that start is initialized to 1 in Line 1, and updated to a new (larger) value ψₗ[1]+1 in Line 20 after the l-th match is found. This update guarantees that the next match computed will be different from any of the previously computed matches.

For each fixed value of i, IoT learning framework 165 computes c[i,j] for j=1, 2, . . . , n in the for loop of Line 5. The condition in Line 6 is true if and only if eᵢ=eⱼ^{A,k}, indicating that IoT learning framework 165 just found a matched pair of events. Due to this match, IoT learning framework 165 has |LCS( [symbol] (start:i), [symbol] (A)(1:j))|=1+|LCS( [symbol] (start:i−1), [symbol] (A) (1:j−1))|. Therefore in Line 7, IoT learning framework 165 sets c[i,j]←c[i−1, j−1]+1=|LCS ( [symbol] (start:i−1), [symbol] (A) (1:j−1))|+1=|LCS( [symbol] (start:i), [symbol] (A)(1:j))|. Otherwise, c[i,j] is either set to c[i−1, j] in Line 9 or c[i,j−1] in Line 10 to guarantee c[i,j]=|LCS ( [symbol] (start:i), [symbol] (A) (1:j))|.

In Line 11, the algorithm checks whether a match of [symbol] (A) in [symbol] (start:i) is found. If this condition is not true, control jumps to Line 21 where i is incremented and the statement of the while loop is executed again if the new value of i does not exceed m, and the algorithm outputs [symbol] if the new value of i exceeds m. If the condition in Line 11 is true, the algorithm backtracks to trace out the newly found match of [symbol] (A) in [symbol] (start:i) in Lines 12 to 19.

In Line 20, the algorithm updates the values of start and i to i to ψₗ[1]+1 and ψₗ[1], respectively. In Line 2, the algorithm initializes the entries of c[ ] in row start−1 to 0 to prepare for the computation of the lightest minimal match of [symbol] (A) in [symbol] (start: m). The previous values in the overwritten rows are no longer needed.

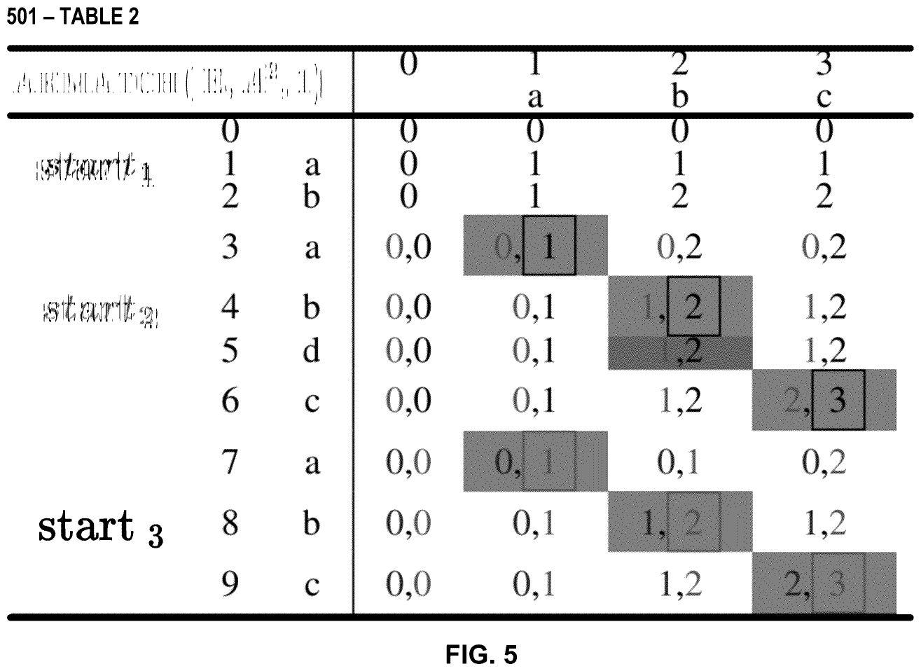

FIG. 5 sets forth Table 2 at element 501, depicting an example graphical illustration of the AkMatch functionality, in accordance with aspects of the disclosure.

Example 4: The example setting was used to illustrate the execution of AkMatch ( [symbol] , A², 1), with the aid of Table 2 (501).

Pattern [symbol] (A²)=(a, b, c) is on top, and sequence [symbol] =(a, b, a, b, d, c, a, b, c) is on the left. To make things clear, start ₁, start 2, and start ₃ are used to denote the different start values. For an entry that is written more than once, comma(s) are utilized to separate these values, with newer values towards the left.

First, IoT learning framework 165 sets start to 1 (denoted by start 1) and initialize c[0, j] to 0 for 0≤j≤3. For i=1, IoT learning framework 165 has c[1,0]=0,

$$c [ 1 , 1 ] = 1 ( since {e}_{1} = {e}_{1}^{{A}^{2} , 1} = a ) ,$$

c[1,2]=1, c[1,3]=1. Similarly, IoT learning framework 165 has c[2,0]=0, c[2,1]=1; c[2,2]=2, c[2,3]=2; c[3,0]=0, c[3,1]=1; c[3,2]=2, c[3,3]=2; c[4,0]=0, c[4,1]=1; c[4,2]=2, c[4,3]=2; c[5,0]=0,c[5,1]=1; c[5,2]=2, c[5,3]=2; c[6,0]=0, c[6,1]=1; c[6,2]=2, c[6,3]=3. Now IoT learning framework 165 has c[i, 3]=3, with i=6. This indicates there is a match of [symbol] (A²) in E that lies within [symbol] (1:6).

The algorithm backtracks from cell [6, 3] to trace out the lightest match of [symbol] (A²) in E that lies within E (1:6). As shown here, the algorithm shades the cells on the backtracking path and adds a frame-box around the value of c[row, col] if the condition in Line 14 is true, and adds a gray background if the condition in Line 16 is true. In cell [6, 3], the algorithm sets ψ₁ [3]→6, and move to cell [5, 2]. In cell [5, 2], the algorithm moves to cell [4, 2]. In cell [4, 2], the algorithm sets ψ₁ [2]→4, and move to cell [3, 1]. In cell [3, 1], the algorithm sets ψ₁ [1]→3, and move to cell [2, 0]. This backtrack stops at cell [2, 0]. By now, the algorithm has found

$${ψ}_{1}^{min , {A}^{2} , 1} = ( 3 , 4 , 6 ) .$$

Note that there may be multiple matches of [symbol] (A²) in [symbol] that lie entirely in [symbol] (1:6). The match (3, 4, 6) computed by the algorithm is minimal and the lightest among these matches. In the example, (1, 4, 6) and (1, 2, 6) also lie within [symbol] (1:6). As illustrated in Example 3, (3, 4, 6) is minimal and is lighter than both (1, 4, 6) and (1, 2, 6).

Next, the algorithm sets start

$$← {ψ}_{1}^{min , {A}^{2} , 1} [ 1 ] + 1 = 4$$

and start the computation of the next match. Some of the cells will be overwritten by the algorithm with values computed with a new start value. The algorithm finds c[9, 3]=3, and backtracks to find the next match

$${ψ}_{2}^{min , {A}^{2} , 1} = ( 7 , 8 , 9 ) ,$$

which is the only match of [symbol] (A²) in [symbol] that lies entirely in [symbol] (4:9).

Then, the algorithm sets start

$$← {ψ}_{2}^{min , {A}^{2} , 1} [ 1 ] + 1 = 8 ,$$

starts the computation of the next match. This time, the algorithm could not find a match. In summary, the algorithm finds two matches of [symbol] (A²) in

$$𝔼 : {ψ}_{1}^{min , {A}^{2} , 1} = ( 3 , 4 , 6 ) and {ψ}_{2}^{min , {A}^{2} , 1} = ( 7 , 8 , 9 ) .$$

Theorem 1: For given [symbol] , A, and k, Algorithm 1 computes list [symbol] of all representatives of equivalence classes of Ψ^{min,A,k}, in increasing order defined by ordering [symbol] . The worst-case running time of the algorithm is O(m²| [symbol] (A)|).

Each match in Ψ^{A,k} can be used as a possible match of the pattern [symbol] (A) of user activity A. In order to avoid double-counting of a device event, the following concept is introduced, according to Definition 5:

Definition 5 (compatible matches): Let ψᵢ^{A,k} be a match in Ψ^{A,k} for A∈ [symbol] [symbol] and k [symbol] {1, | [symbol] (A)|}. Let ψ_{i′}^{A′,k′} be a match in Ψ^{A′,k′} for A′∈ [symbol] and k′∈{1, | [symbol] (A′)|}. It is stated that ψᵢ^{A,k} and ψ_{i′}^{A′,k′} are compatible if the intervals of ψᵢ^{A,k} and ψ_{i′}^{A′,k′} do not overlap according to Equation 4, set forth below, as follows:

$${ψ}_{i , 1}^{A , k} > {ψ}_{{i}^{′} , \vert \vert ( {A}^{′} ) \vert}^{{A}^{′} , {k}^{′}} or {ψ}_{i , \vert ( A ) \vert}^{A , k} < {ψ}_{{i}^{′} , 1}^{{A}^{′} , {k}^{′}} .$$

Let [symbol] |Ψ^{A,k} be the set of all matches of a pattern [symbol] (A) in [symbol] , for some user activity A∈ [symbol] .

Assume that W>0 is a given real number and that for each i=1, 2, . . . , | [symbol] | and each k=1, 2, . . . , | [symbol] (Aⁱ)|, there is a nonnegative real number w(i,k)≥0 such that [symbol] [symbol] w(i,k)=W. For each ψⱼ^{A}^{ⁱ}^{,k}∈Ψ, IoT learning framework 165 associates a weight ψⱼ^{A}^{ⁱ}^{,k}·weight=w(i,k). Let Φ⊆Ψ be a subset of Ψ. The weight

$$w ( Φ ) = {\sum }_{{ψ}_{j}^{{A}^{i} , k} ∈ Φ} w ( i , k ) .$$

Φ is said to be compatible if the elements in Φ are mutually compatible.

Proof of Theorem 1: Algorithm 1 is a modification of the algorithm for computing an LCS of two sequences [symbol] (start: m) and [symbol] (A). The difference lies in (i) only of interest is the computation of an LCS that is identical to [symbol] (A), not any proper subsequence of [symbol] (A); and (ii) multiple matches are computed, rather than one. Therefore the details that are well-known in the correctness of the algorithm for LCS are omitted.

The term n is used to denote | [symbol] (A)|. Computing one LCS requires O(mη) time in the worst-case. The algorithm computes O(m) LCSs. Hence the worst-case running time is O(m²η).

If LCS ( [symbol] , [symbol] (A))≠ [symbol] (A), Algorithm 1 outputs a null list, as Ψ^{min,A,k}=Ψ^{A,k}=Ø in this case. In the rest of the proof, it may be assumed that LCS ( [symbol] , [symbol] (A))= [symbol] (A). Hence the condition in Line 11 is true at least once during the execution.

Each time when the condition in Line 11 is true, it is known that [symbol] (start:i−1) contains no subsequence that is identical to [symbol] (A), and that [symbol] (start:i) contains a subsequence that is identical to [symbol] (A). Therefore Lines 12-19 correctly compute a match ψₗ=(ψₗ[1], ψₗ[2], . . . , ψₗ[η]) of [symbol] (A) in [symbol] (start:i).

Let x15 and x18 denote the number of times Line 15 and Line 18 are executed (with start and l fixed), respectively. Since control enters the while loop in Line 13 with col initialized to η, and exits the while loop when col is reduced to 0, IoT learning framework 165 has x15+x18=η. Because a match of [symbol] (A) in [symbol] is found that lies entirely in [symbol] (start: i), IoT learning framework 165 has x15=η. Hence x18=0. In other words, between the executions of Line 12 and Line 19, Line 15 is executed exactly η times, and Line 18 is executed zero times.

When IoT learning framework 165 traces out a newly computed match of [symbol] (A) in [symbol] , IoT learning framework 165 first initializes row to i and col to η. If e_{row}=e_{col}^{A,k}, IoT learning framework 165 decrements both row and col by 1. Otherwise, IoT learning framework 165 decrements row by 1 and keep col unchanged. Therefore, the match IoT learning framework 165 traces out is the lightest among all matches of [symbol] (A) in E that lie entirely in [symbol] (start,i).

When the condition in Line 11 becomes true for the first time, IoT learning framework 165 may determine that there is no match of [symbol] (A) in E that lies within [symbol] (start:i)= [symbol] (1: i). Therefore ψ₁=(ψ₁ [1], ψ₁ [2], . . . , ψ₁[η]) is the lightest match of [symbol] (A) in [symbol] , which implies that it is minimal. Let Let ϕ=(ϕ[1], ϕ[2], . . . , ϕ[η]) be any minimal match of [symbol] (A) in [symbol] that is not equivalent to ψ₁, IoT learning framework 165 may have ϕ[1]≥ψ₁ [1]+1. Therefore ψ₂ computed by IoT learning framework 165 using the algorithm is the lightest minimal match of [symbol] (A) in [symbol] that is not equivalent to ψ₁. Similarly, ψ₃ computed by the algorithm is the lightest minimal match of [symbol] (A) in E that is not equivalent to ψ₁ or ψ₂. In general, ψ₁ computed by the algorithm is the lightest minimal match of [symbol] (A) in [symbol] that is not equivalent to ψⱼ for j=1, 2, . . . , l−1. This completes the proof of the theorem.

The following optimization problem is studied below according to Problem 3. Problem 3 (MaxWCM (Φ,w)): Let W>0 be given, together with weights w (i,k)≥0 for i=1, 2, . . . , | [symbol] | and k=1, 2, . . . | [symbol] (Aⁱ)| such that [symbol] [symbol] ^{)|}w(i,k)=W. Let Φ be a subset of Ψ. The weighted maximum compatible match selection problem (MaxWCM) on (Φ,w) seeks for a maximum weight compatible subset Φ_{w,opt} ⊆Φ.

Algorithm 1 may be applied to compute the list [symbol] of matches in Ψ^{min,A}^{ⁱ}^{,k} for i=1, . . . , | [symbol] |, k=1, . . . , | [symbol] (Aⁱ)|.

Let Ψ̅= [symbol] {ψⱼ^{A}^{ⁱ}^{,k}|ψⱼ^{A}^{ⁱ}^{,k} ∈ [symbol] }. The following theorem shows that an optimal solution of the Max WCM problem on (Ψ̅,w) is also an optimal solution of the MaxWCM problem on (Ψ,w). Note that Ψ̅ is a subset of Ψ whose cardinality is much smaller than that of Ψ.

Theorem 2: The MaxWCM(Ψ,w) problem has an optimal solution Ψ_{w,opt} ⊆Ψ̅. Furthermore, such an optimal solution can be obtained by solving the MaxWCM(Ψ̅,w) problem.

Note that Ψ contains every match of [symbol] , for every Aⁱ∈ [symbol] and every k∈{1≤k≤| [symbol] (Aⁱ)|}. Ψ^{min} is a small subset of Ψ, consisting of the minimal matches only. Ψ̅ is a small subset of 4 min, consisting of the representatives of its equivalence classes. Hence |Ψ̅| is much smaller than |Ψ| in general. Theorem 2 shows that IoT learning framework 165 does not lose any important information by diverting attention away from the very large set Ψ to the much smaller set Ψ̅.

Proof of Theorem 2: Let Ψ^{min}= [symbol] |Ψ^{min, A}^{ⁱ}^{,k}. First it is proven that there is an optimal solution Ψ_{w,opt} of the MaxWM(Ψ,w) problem such that Ψ_{w,opt} ⊆Ψ^{min}. Let Ψ_{w,opt} be an arbitrary optimal solution for the MaxWCM(Ψ,w) problem. If Ψ_{w,opt} ⊆Ψ^{min}, there is nothing to be proved. Let ψⱼ^{A}^{ⁱ}^{,k} be a match in Ψ_{w,opt} such that ψⱼ^{A}^{ⁱ}^{,k} ∈Ψ^{A}^{ⁱ}^{,k}†Ψ^{min, A}^{ⁱ}^{,k.} Let ψ_{j′}^{A}^{ⁱ}^{,k} be a minimal match of [symbol] (Aⁱ) in [symbol] such that [ψⱼ^{A}^{ⁱ}^{,k}[1], ψⱼ^{A}^{ⁱ}^{,k}[|] [symbol] (Aⁱ)|] is a proper subinterval of [ψⱼ^{A}^{ⁱ}^{,k}[1], ψⱼ^{A}^{ⁱ}^{,k}[| [symbol] (Aⁱ)|]. Since the two matches have the same weight w(i,k), IoT learning framework 165 may obtain another optimal solution by replacing ψⱼ^{A}^{ⁱ}^{,k} with ψ_{j′A}^{i,k}. Therefore, IoT learning framework 165 may obtain another optimal solution to the MaxWCM(Ψ,w) problem with one fewer non-minimal match than Ψ_{w,opt}. Repeating this process for each non-minimal match in Ψ_{w,opt}, IoT learning framework 165 may obtain an optimal solution to the MaxWCM(Ψ,w) problem consisting of matches in Ψ^{min} only.

For WLOG, assume that Ψ_{w,opt} ⊆Ψ^{min} in the rest of this proof. Next, it is shown that the optimal solution Ψ_{w,opt} can be transformed to another optimal solution Ψ_{w,opt} ⊆Ψ̅.

Suppose there is an element ψⱼ^{min,A}^{ⁱ}^{,k} ∈Ψ_{w,opt} that is not in Ψ̅. Let ψⱼ_{_{lightest}}^{min,A}^{ⁱ}^{,k} be the lightest element in the equivalence class which contains ψⱼ^{min,A}^{ⁱ}^{,k}. In such an event, ψⱼ_{ₘᵢₙ}^{min,A}^{ⁱ}^{,k} can be replaced with ψψⱼ_{_{lightest}}^{min,A}^{ⁱ}^{,k}. This transformation does not destroy compatibility (since ψⱼ_{_{lightest}}^{min,A}^{ⁱ}^{,k} and ψⱼ^{min,A}^{ⁱ}^{,k} have the same interval), nor does it change the weight of the set (since ψⱼ_{_{lightest}}^{min,A}^{ⁱ}^{,k} and ψⱼ^{min,A}^{ⁱ}^{,k} have the same weight w (i,k)). Note that ψⱼ_{_{lightest}}^{min,A}^{ⁱ}^{,k} ∈Ψ̅. Therefore, through a finite number of such transformations, IoT learning framework 165 can transform the optimal solution Ψ_{w,opt} to another optimal solution Ψ_{w,opt}⊆Ψ̅.

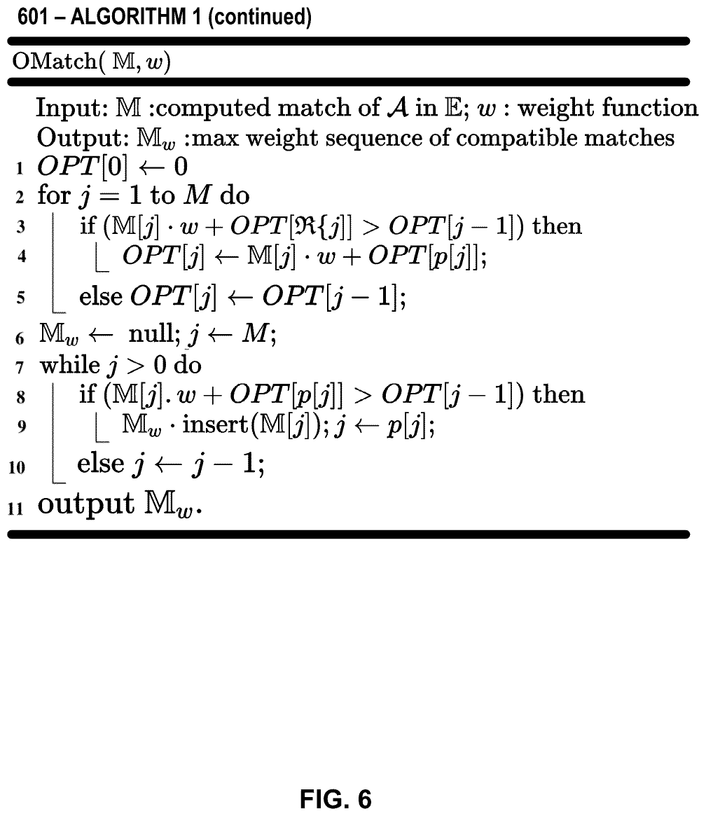

FIG. 6 sets forth Algorithm 2 at element 601, depicting an example implementation of the OMatch( [symbol] ,w) functionality for computing a compatible sub-sequence of user activity patterns, in accordance with aspects of the disclosure.

Inferring Optimal Sequence of User Activity Patterns with a Given Weight (Phase 2A):

In this section, an efficient algorithm is presented for solving the MaxWCM problem on ( [symbol] ,w) for any given weight w. For ease of presentation, a uniform representation of the matches in Ψ is utilized, explained in the following.

Each match ψⱼ^{min,A}^{²}^{,k} ∈Ψ̅ is characterized by a 5-tuple (i,k, α,β,w), where

$$α = {ψ}_{j , 1}^{min , {A}^{i} , k} = {ψ}_{j}^{min , {A}^{i} , k} , β = {ψ}_{j , \vert ( {A}^{i} ) \vert}^{min , {A}^{i} , k} = {ψ}_{j}^{min , {A}^{i} , k} [ \vert ( {A}^{i} ) \vert ] ,$$

and ψⱼ^{min,A}^{ⁱ}^{,k} is the weight w(i,k) associated with [symbol] (Aⁱ).

Let m_{i,k}=| [symbol] |, i=1, . . . , | [symbol] |, k=1, . . . | [symbol] (Aⁱ)|. Let M= [symbol] [symbol] ^{)|}m_{i,k}. Let [symbol] be a 1-D array of M 5-tuples (i,k, α,β,w), each of which corresponds to a match computed. The array [symbol] can be sorted according to nondecreasing value of β in O(M log M) time. Without loss of generality, it may be assumed that array [symbol] is already sorted. It may further be assumed that IoT learning framework 165 has computed a 1-D array p of M+1 integers where p[0]=0 and p[j] is the largest integer t∈{0, 1, . . . , j−1} such that [symbol] [t]. β< [symbol] [j]. α. Here the technical convention that [symbol] [0]·β=−∞ is utilized. Algorithm 2 provides a solution for the MaxWCM(Ψ,w) problem.

Theorem 3: Algorithm 2 computes a compatible subsequence [symbol] _{w} of user activity patterns in [symbol] with maximum total weight. Its worst-case running time is O(M).

IoT learning framework 165 may implement a solution to E2AP and E2A utilizing the following flow. For each Aⁱ∈ [symbol] , i=1, 2, . . . , | [symbol] |, IT learning framework 165 may determine the possible patterns [symbol] (Aⁱ)={ [symbol] (Aⁱ), [symbol] (Aⁱ), . . . , [symbol] ^{)|} (Aⁱ)}. Given the sequence [symbol] of device events, by repeated applications of Algorithm 1 for each Aⁱ∈ [symbol] , i=1, 2, . . . , | [symbol] | and each k∈{0, 1,2, . . . , | [symbol] (Aⁱ)|}, IoT learning framework 165 can compute [symbol] of representative matches in Ψ^{min,A}^{ⁱ}^{,k} for each i and k. The union of these lists is Ψ̅. Given the weights w(i,k), IoT learning framework 165 can apply Algorithm 2 to compute [symbol] _{w}. From [symbol] _{w}, IT learning framework 165 may obtain a sequence of | [symbol] _{w}| user activity patterns [symbol] ^{w}=( [symbol] ^{w}[1], [symbol] ^{w}[2], . . . , [symbol] ^{w}[| [symbol] _{w}|]), where [symbol] ^{w}[j]= [symbol] , j=1, 2, . . . , | [symbol] _{w}|. Ignoring the patterns, IoT learning framework 165 may obtain a sequence of | [symbol] _{w}| user activities [symbol] ^{w} ( [symbol] ^{w}[1], [symbol] ^{w}[2], . . . , [symbol] ^{w}[| [symbol] _{w}|]), where [symbol] ^{w} [symbol] , j=1, 2, . . . , | [symbol] _{w}|. IoT learning framework 165 may use [symbol] ^{w} and [symbol] ^{w} for solving for E2AP and E2A, respectively.

Example 5: Let A=(A¹, A², A²) be a sequence of user activities, where A¹ and A² are as in the example setting. Applying the AkMatch algorithm, IT learning framework 165 obtains [symbol] =((1,2), (3,4), (7,8)), [symbol] =((3,4,6), (7,8,9)), and [symbol] =((1,2), (3,4), (7,8)). Putting these 8 matches into array [symbol] and sorting according to the β field, IoT learning framework 165 has [symbol] [1]=(1,1,1,2, w(1,1)), [symbol] [2]=(2,2,1,2, w(2,2)), [symbol] [3]=(1,1,3,4, w(1,1)), [symbol] [4]=(2,2,3,4, w(2,2)), [symbol] [5]=(2,1,3,6, w(2,1)), [symbol] [6]=(1,1,7,8, w(1,1)), [symbol] [7]=(2,2,7,8, w(2,2)), [symbol] [8]=(2,1,7,9, w(2,1)). IoT learning framework 165 also has p[0]=p[1]=p[2]=0, p[3]=p[4]=p[5]=2, p[6]=p[7]=p[8]=5.

Suppose w (1,1)=1.4, w(2,1)=1.6, w(2,2)=0. The OMatch algorithm will compute [symbol] _{w}=( [symbol] [1], [symbol] [5], [symbol] [8]).

Note that [symbol] [1] corresponds to [symbol] (A¹), [symbol] [5] corresponds to [symbol] (A²), and [symbol] [8] corresponds to [symbol] (A²). This leads to the sequence of user activity patterns Sw=(S1(A1), S1(A2), S1(A2)) as a solution to E2AP and the sequence of user activities Aw=(A1, A2, A2) as a solution to E2A. Note that the edit distance between [symbol] and [symbol] (A¹)∥ [symbol] (A²)∥ [symbol] (A²) is 1.

Suppose w(1,1)=1.6, w(2,1)=1.4, w(2,2)=0. The OMatch algorithm will compute [symbol] _{w}=( [symbol] [1], [symbol] [3], [symbol] [6]) This leads to the sequence of user activity patterns [symbol] =( [symbol] (A¹), [symbol] (A²), [symbol] (A²)) as a solution to E2AP and the sequence of user activities [symbol] =(A¹, A², A²) as a solution to E2A. Note that the edit distance between [symbol] and [symbol] (A¹)∥ [symbol] (A¹)∥ [symbol] (A¹) is 3.

Example 5 shows that the value of the weights has a big impact on the quality of [symbol] ( [symbol] , respectively) as a solution to E2AP (E2A, respectively). In Phase 2B, IoT learning framework 165 utilizes unsupervised learning to compute a good weight, by minimizing a properly defined loss function.

Proof of Theorem 3: Algorithm 2 is the dynamic programming algorithm for weighted interval scheduling.

### Learning Optimal Weights (Phase 2B):

As described above, w uniquely decides [symbol] _{w}, which in turn uniquely decides [symbol] and [symbol] , as the solution to E2AP and E2A, respectively. In general, [symbol] and [symbol] ( [symbol] and [symbol] , respectively) are not equally good solutions to E2AP (E2A, respectively) when w≠w′, as illustrated in Example 5.

In this section, an unsupervised learning approach is presented via which to learn a proper weight assignment. Both supervised and unsupervised learning can be used. Since the E2AP problem asks for activity patterns rather than activities, a loss function can be defined that makes unsupervised learning more adaptive. Hence the focus is on unsupervised learning. The application of supervised learning as well as distributed unsupervised learning to this problem may similarly be leveraged as alternative or additional expansions to the methodologies described herein.

Provided below, the loss function is defined as the edit distance between [symbol] and the concatenation of the activity patterns computed. The loss function is a non-differentiable function of the continuous variables corresponding to the weights. Still further, the exact algorithm to minimize the loss function with all but one variable fixed is defined and implemented as described. This algorithm is used as a sub-routine to design a coordinated descent algorithm to minimize the loss function.

### Loss Function and Optimization Problem Formulation:

Let [symbol] be the sequence of device events obtained by concatenating the activity patterns in [symbol] , according to Equation 5, set forth below, as follows:

$$= [ 1 ] ‖ [ 2 ] ‖ … ‖ [ \vert {w}_{} \vert ] .$$

Without any knowledge of the ground truth, the loss function for parameter w is defined as the edit distance between [symbol] and [symbol] , denoted by d( [symbol] , [symbol] ). Here it is assumed that the operations deletion, insertion, and substitution all have costs equal to 1.

Let n=| [symbol] |; nⱼ=| [symbol] (A^{j})| for j=1, 2, . . . , n; and N=Σⱼ₌₁ⁿ nⱼ. Then w consists of N variables. A natural approach to obtaining the optimal values of w is to solve the following optimization problem according to Equation 6, set forth below as follows:

$${minimize}_{w} f ( w ) = d ( , ) ,$$

where Equation 6 is subject to Equation 6A, set forth as follows:

$${\sum }_{i = 1}^{n} {\sum }_{k = 1}^{\vert ( {A}^{i} ) \vert} w ( i , k ) = N ,$$

and further subject to Equation 6B, set forth as follows:

$$w ( i , k ) \geq 0 , ∀ i = 1 , … , n , ∀ k = 1 , … , \vert ( {A}^{i} ) \vert .$$

Equation 6 and its sub-parts are difficult to solve, as the objective function is non-differentiable and non-convex. In an effort to design a coordinated descent algorithm for solving Equation 6, an optimization problem is evaluated to minimize the objective function over one of the N variables. This problem may be formally defined in the following, where w(i,k) is the variable, for a chosen pair (i,k), according to Equation 7, set forth below as follows:

$${minimize}_{w ( \underline{i} , k )} f ( w ) = d ( , ) ,$$

subject to Equation 7A, set forth as follows:

$$w ( \underline{i} , k ) \geq 0.$$

Equation 7 may be referred to as the 1-D problem, and Equation 6 may be referred to as the N-D problem. An exact algorithm is provided for solving Equation 7 and a coordinate descent algorithm is provided for solving Equation 6.

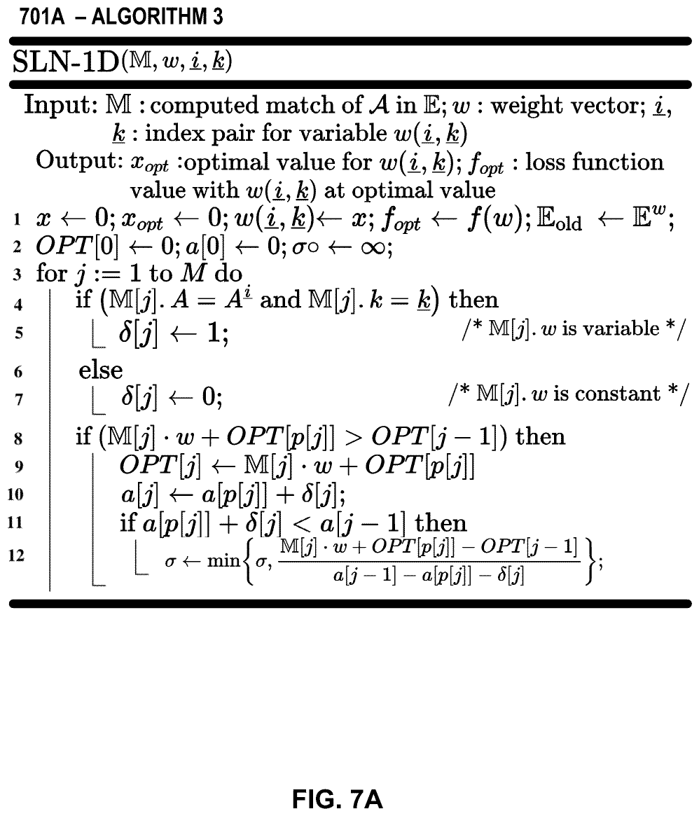

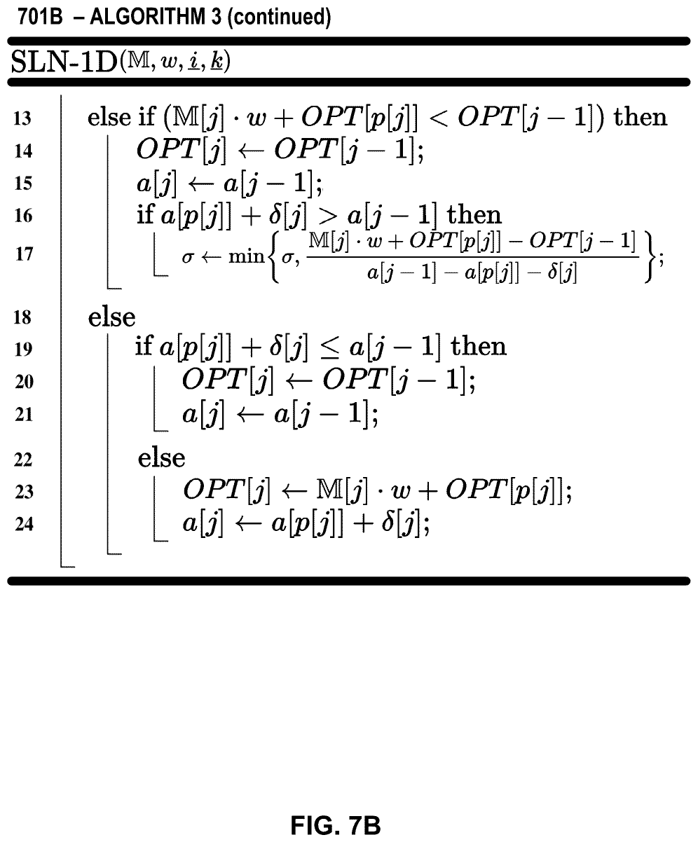

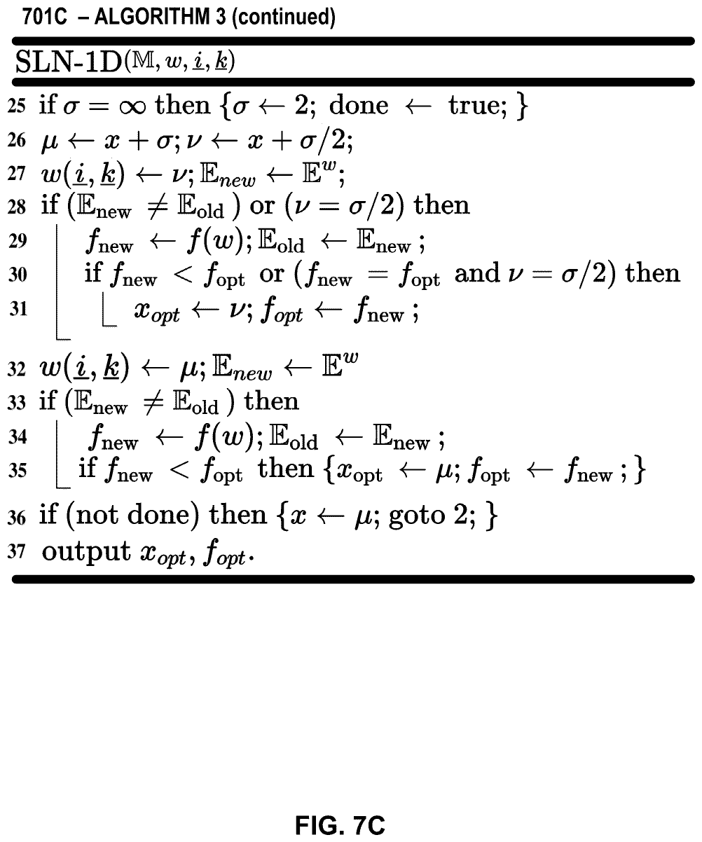

FIGS. 7A, 7B, and 7C set forth Algorithm 3 at elements 701A, 701B, and 701C depicting an example implementation of the SLN-1D functionality for computing an optimal solution to the 1-D problem, in accordance with aspects of the disclosure.

### Exact Algorithm for 1-D Optimization:

An algorithm named SLN-1D enables IoT learning framework 165 to compute an optimal solution of the 1-D problem, and list it as Algorithm 3. Algorithm 3 performs many rounds of Algorithm 2, by tracking the trend of the computed matches with the value of w(i,k) taking on larger and larger values. Here [symbol] and p are the same as in Algorithm 2. The key observation behind the design of Algorithm 3 is that the objective function ƒ(w) in Equation 7 is a step function of w(i,k) with a finite number of different function values, each of which is defined on an interval for w(i,k). IoT learning framework 165 can evaluate ƒ(w) in an interior point and on the boundaries of each of these intervals. IoT learning framework 165 may find the boundaries of these intervals by performing a left-to-right scan. IoT learning framework 165 may start the scan at w(i,k)=0 (Line 1). For each value x of w(i,k), IoT learning framework 165 computes real numbers μ and ν where μ<x and

$$v = \frac{x + μ}{2}$$

such that (i) [symbol] does not change when w(i,k) is varying in the interval (x, μ) and (ii) such that [symbol] will change when w(i,k) is increased from x to μ or from x to μ plus an infinitesimal amount.

IoT learning framework 165 evaluates ƒ(w) by setting w(i,k) to ν and μ, respectively. Then repeat the process with x set to μ, as long as such a μ exists. When such a μ does not exist, IoT learning framework 165 sets μ→x+2 and ν→x+1, and evaluate ƒ(w) by setting w(i,k) to ν and μ, respectively. Lines 2-25 carry out the computation of w(i,k) for the current value of x. In Line 26, IoT learning framework 165 sets u→x+σ and ν→x+σ/2. Lines 27-35 perform the function evaluations at ν and μ, and related book-keeping operations.

The computation of σ=μ−x from x is carried out by operations similar to the operations in the dynamic programming algorithm for weighted interval scheduling, e.g., Lines 1-6 of Algorithm 2. There are additional operations needed to compute σ.

Before proceeding with the explanation of the algorithm, the meaning of two variables are described: array δ[ ] and array a[ ]. For j=1, 2, . . . , M, δ[j]=1 if [symbol] [j]·w is the variable weight w(i,k), δ[j]=0 otherwise. For j=1, 2, . . . , M, IoT learning framework 165 may use a [j] to denote the number of selected matches/intervals in the optimal solution of [symbol] (1:j) whose weight is w(i,k), when w(i,k) is set to x plus an infinitesimal amount.

In Line 2, IT learning framework 165 sets OPT[0]→0, a [0]→0, σ→∞. The for loop in Lines 3-24 computes the values for δ[j], OPT[j], α[j], and reduces σ accordingly. The body of the for loop starts with the computation of δ[j] in Lines 4-7. This is followed by three mutual exclusive parts: Lines 9-12 (when [symbol] [j]·w+OPT[p[j]]>OPT[j−1]), Lines 14-17 (when [symbol] [j]·w+OPT[p[j]]<OPT[j−1]), and Lines 19-24 (when [symbol] [j]·w+OPT[p[j]]=OPT[j−1]).

When [symbol] [j]·w+OPT[p[j]]>OPT[j−1], the optimal solution of [symbol] (1:j) consists of [symbol] [j] and the optimal solution of [symbol] (1:p[j]). This will not change even when w(i,k) is increased by an infinitesimal amount, due to the strict inequality. Hence a [j] is computed according to Line 10. If α[p[j]]+δ [j]<α[j−1], the inequality [symbol] [j]·w+OPT[p[j]]>OPT[j−1] will no longer be true when w(i,k) is increased by an amount equal to

$$\frac{[ j ] \cdot w + O P T [ p [ j ] ] - \overline{O} P T [ j - 1 ]}{a [ j - 1 ] - a [ p [ j ] ] - δ [ j ]} .$$

Therefore, IoT learning framework 165 sets σ to the smaller of its current value and

$$\frac{[ j ] \cdot w + OPT [ p [ j ] ] - OPT [ j - 1 ]}{a [ j - 1 ] - 1 [ p [ j ] ] - δ [ j ]}$$

### in Line 12.

When [symbol] [j]·w+OPT[p[j]]<OPT[j−1], the optimal solution of [symbol] (1:j) is the optimal solution of [symbol] (1:j−1). This will not change even when w(i,k) is increased by an infinitesimal amount, due to the strict inequality. Hence a [j] is computed according to Line 15. If α[p[j]]+δ[j]>α[j−1], IoT learning framework 165 will have [symbol] [j]·w+OPT[p[j]]>OPT[j−1] when w(i,k) is increased by an amount equal to an infinitesimal plus

$$\frac{[ j ] \cdot w + O PT [ p [ j ] ] - O P T [ j - 1 ]}{a [ j - 1 ] - 1 [ p [ j ] ] - δ [ j ]} .$$

Therefore, IoT learning framework 165 sets σ to the smaller of its current value and

$$\frac{[ j ] \cdot w + O PT [ p [ j ] ] - O P T [ j - 1 ]}{a [ j - 1 ] - 1 [ p [ j ] ] - δ [ j ]}$$

### in Line 17.

When [symbol] [j]·w+OPT[p[j]]=OPT[j−1], the optimal solution of [symbol] (1:j) is the optimal solution of [symbol] (1:j−1), with an objective function value equal to OPT[j− [symbol] [j]. w+OPT[p[j]]. If a [p[j]]+δ[j]≤α[j−1], IoT learning framework 165 will have [symbol] [j]·w+OPT[p[j]]≤OPT[j−1] when w(i,k) is increased by an infinitesimal amount. Note that [symbol] [j]·w+OPT[p[j]]≤OPT[j−1] implies that the optimal solution for [symbol] (1:j) is the optimal solution for [symbol] (1:j−1). Therefore, IoT learning framework 165 may select the assignment of OPT[j] in Line 20 and set the value of a [j] according to Line 21. If a [p[j]]+δ[j]>α[j−1], IoT learning framework 165 will have [symbol] [j]·w+OPT[p[j]]>OPT[j−1] when w(i,k) is increased by an infinitesimal amount. Note that [symbol] [j]·+OPT[p[j]]>OPT[j−1] implies that the optimal solution for [symbol] (1:j) consists of [symbol] [j] and the optimal solution for [symbol] (1: p[j]). Therefore, IoT learning framework 165 may select the assignment of OPT[j] in Line 23 and set the value of a [j] according to Line 24.

If IoT learning framework 165 finds σ=∞ in Line 25, IoT learning framework 165 has identified that x is the left end of the rightmost interval for w(i,k). However, IoT learning framework 165 may not have determined whether the function is right-continuous at x. Therefore, IoT learning framework 165 sets σ to 2 (which can be replaced by any other positive number). In Line 26, IoT learning framework 165 sets μ←x+σ and ν←x+0.5σ. Lines 27-35 are straightforward which do not need explanation. If the current x is not the left end of the rightmost interval, IoT learning framework 165 sets x←u and repeat the process.

Theorem 4: For any given value of w and index pair (i,k), Algorithm 3 terminates with an optimal solution to Equation 7. The worst-case time complexity of Algorithm 3 is O(M²).

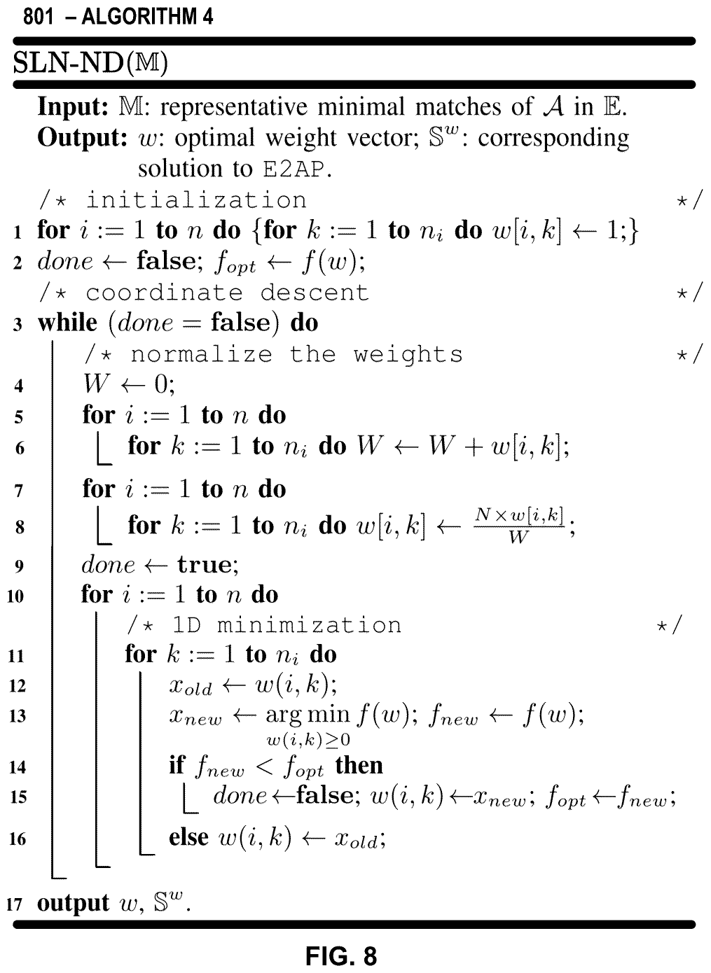

FIG. 8 sets forth Algorithm 4 at element 801, depicting an example implementation of the SLN-ND functionality for applying a round-robin coordinate descent approach as part of solving an optimization problem, in accordance with aspects of the disclosure.

### Coordinate Descent for N-D Optimization:

The optimization problem defined by Equation 6 is difficult to solve for two reasons, including: (i) the objective function is non-differentiable; and (ii) the optimization problem is non-convex. Therefore, the problem is tackled via a round-robin coordinate descent approach. This is presented in Algorithm 4.

The following explains the main steps of Algorithm 4. Line 1 performs the initialization of the weights. It then performs coordinate descent until convergence. Lines 4-8 perform normalization so that the N non-negative weights sum up to N. Instead of normalizing after each one-dimensional minimization, processing normalizes it after one round-robin over all N variables. Lines 10-16 perform one round of coordinated descent. For each (i,k), processing performs 1-D minimization of ƒ(w) over w(i,k) by calling Algorithm 3.

Example 6: Assume the same setting as in Example 5. Let [symbol] contain the 8 matches computed. IoT learning framework 165 may apply Algorithm 4 to this setting, with the initial weights w(1,1)=1, w(2,1)=1, w(2,2)=1. The objective function value is ƒ(w)=3, with [symbol] _{w}=( [symbol] [1], [symbol] [3], [symbol] [6]).

Algorithm 4 performs minimization over w(1,1), there is no improvement. It then performs minimization over w(2,1). The objective function value is reduced to 1 with w(1,1)=1, w(1,1)=1, w(2,1)=2, w(2,2)=1. It then performs minimization over w(2,2), there is no improvement. After normalization, IoT learning framework 165 will have

$$w ( 1 , 1 ) = \frac{3}{4} , w ( 2 , 1 ) = \frac{3}{2} , w ( 2 , 2 ) = \frac{3}{4} .$$

The algorithm performs minimization over w(1,1), w(2,1), and w(2,2). None of these produce any improvement. The algorithm terminates, with

$$w ( 1 , 1 ) = \frac{3}{4} , w ( 2 , 1 ) = \frac{3}{2} , w ( 2 , 2 ) = \frac{3}{4} ; f ( w ) = 1 ; {w}_{} = ( [ 1 ] , [ 5 ] , [ 8 ] ) ; and = ( ( {A}^{1} ) , ( {A}^{2} ) , ( {A}^{2} ) ) .$$

### Proof of Theorem 4:

Proof of Theorem 4: Algorithm 3 starts with setting w(i,k) to 0, the minimum possible value for w(i,k). It then scans left-to-right to evaluate function values at chosen points.

Suppose that IoT learning framework 165 is at a current value x≥0 of w(i,k). IoT learning framework 165 may perform the dynamic programming algorithm for weighted interval scheduling to compute a set of matches for the interval scheduling problem of M(1:j) for j=1, 2, . . . , M.

In addition to computing the current set of intervals, IoT learning framework 165 may also check the trend when w(i,k) is increased by an infinitesimal amount. For this purpose, IoT learning framework 165 may utilize a [j] to denote the number of selected intervals for [symbol] M(1:j) whose weight is w(i,k). If IoT learning framework 165 finds [symbol] [j]·w+OPT[p[j]]>OPT[j−1] in Line 8, [symbol] [j] is selected in the optimal solution for [symbol] (1:j). However, if the condition in Line 11 is also true, then the condition in Line 8 will no longer be true if w(i,k) is increased from its current value of x to

$$x + \frac{[ j ] \cdot w + O PT [ p [ j ] ] - O P T [ j - 1 ]}{a [ j - 1 ] - 1 [ p [ j ] ] - δ [ j ]}$$

plus an infinitesimal amount. Therefore, IoT learning framework 165 may add a corresponding upper-bound on σ in Line 12.

If IoT learning framework 165 finds [symbol] [j]·w+OPT[p[j]]<OPT[j−1] in Line 8, [symbol] [j] is not selected in the optimal solution for [symbol] (1:j), and control goes to Line 14. However, if the condition in Line 16 is also true, then the condition in Line 8 will become true if w(i,k) is increased from its current value of x to

$$x + \frac{𝕄 [ j ] \cdot w + O P T [ p [ j ] ] - OPT [ j - 1 ]}{a [ j - 1 ] - a [ p [ j ] ] - δ [ j ]}$$

plus an infinitesimal amount. Therefore, IoT learning framework 165 may add a corresponding upper-bound on σ in Line 17.

In Lines 19-24, IoT learning framework 165 sets the correct value of a[j] to reflect the trend of change of [symbol] when w(i,k) is increased from its current value of x by an infinitesimal amount.

Algorithm 3 considers all possible cases of the upper bound. If the condition in Line 25 is true, IoT learning framework 165 has reached the right end. Otherwise, IoT learning framework 165 may continue the left-to-right scan. Given the discrete feature of the dynamic programming algorithm, IoT learning framework 165 need not have determined whether the function is left continuous or right continuous at the boundary points. Therefore, IoT learning framework 165 may also evaluate the function value at the mid-point of x and u, which is ν. Since the function only takes O(M) different values, the goto statement in Line 36 is executed O(M) times. Since the execution of Line 2 to Line 35 uses O(M) time, the algorithm has a worst-case time complexity O(M2).

Theorem 5: Algorithm 4 stops after a finite number of iterations. Let w be the weight at the end of the algorithm. Then ƒ(w) cannot be reduced by minimizing over any single variable w(i,k).

Algorithm 4 does not guarantee finding an optimal solution to Equation 6. Similar to most machine learning algorithms, Algorithm 4 produces a solution to Equation 6 that cannot be improved by optimizing along any of the coordinates. A theoretical bound is not known on the performance gap of the algorithm. However, extensive experiments show that the algorithm performs well. Besides proving that the algorithm converges in a finite number of iterations, there is no determined theoretical bound on the worst-case running time of the algorithm. Given the non-convex nature of the problem, it is unlikely to compute an optimal solution in polynomial time.

### Proof of Theorem 5:

Let w^{[0]} be the initial weight vector. ƒ(w^{[0]}) is a non-negative integer. Whenever the algorithm finds an improved solution, the objective function value is reduced by at least 1. Therefore the algorithm is guaranteed to terminate. When the algorithm terminates, it is at a weight vector from which the objective function value cannot be improved by minimization over any of the N variables. This proves the theorem.

### Performance Evaluations:

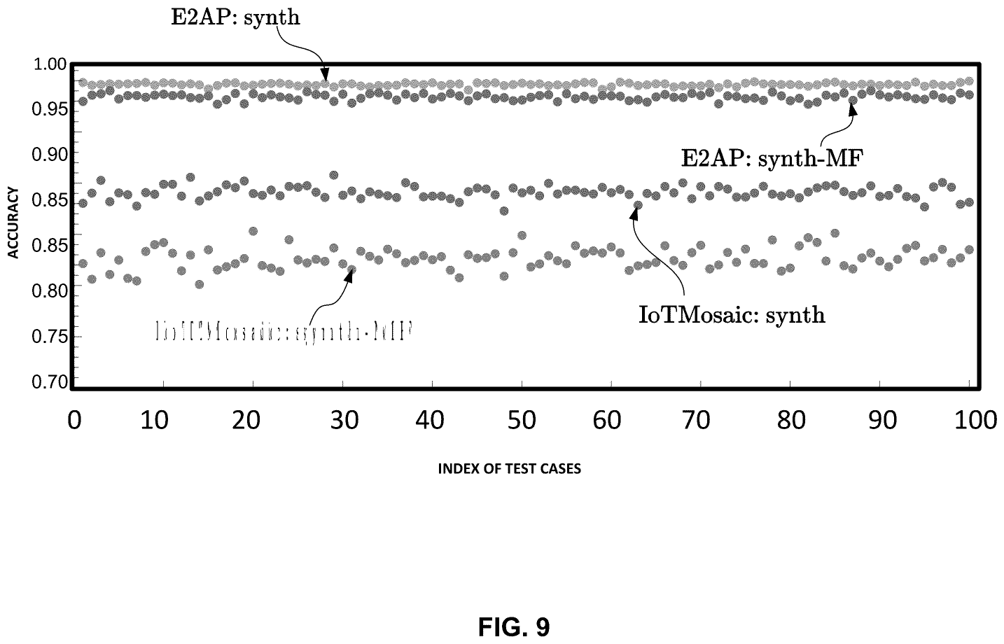

FIG. 9 depicts a chart of the various performances of E2AP and IoTMosaic on synth/synth-MF test cases, in accordance with aspects of the disclosure. As shown here, each test case consists of a distinct sequence of 2,959 user activities and a corresponding sequence of device events. Each dot in FIG. 9 shows the accuracy achieved by the indicated algorithm on a distinct test case. The chart provides the accuracy of IoTMosaic and E2AP on 200 synthetically generated test cases (100 test cases with device malfunctions, and 100 test cases without device malfunctions) for the distinct sequence of user activities and corresponding sequence of device events, following the distribution of the real data.

The scheme was implemented and compared it with IoTMosaic. The solution was not compared with or Peek-a-Boo, since many devices used in are simple sensors without Internet connectivity and Peek-a-Boo infers user activities from the states of devices and sensors, rather than solely from the sequence of device events. The evaluation used E2AP to denote the scheme, and IoTMosaic to denote the scheme in. The evaluation studied the performance on both real data from the smart home test-bed, and synthetic data generated following the patterns observed in the real data.

The evaluation setup and metrics are discussed below, followed by the evaluation results and the observations/analyses. The results show that E2AP exhibits high accuracy and stability, and outperforms IoTMosaic.

Evaluation Setup and Metrics: The evaluation used the data collected from a smart home, involving 21 distinct user activities and 25 distinct device events from 11 different IoT devices. Experimental data were collected over a period of two months, with a total of 2,959 user activities, and 15,420 corresponding device events (computed from network traffic using IoTAthena). The evaluation calls these data real data and denotes them as real. The evaluations studied three cases: (i) 387 user activities (2,013 events) in the first week, (ii) 1,494 user activities (7,934 events) in the first month, (iii) 2,959 user activities (15,420 events) throughout the experiment.

In the real data, two device events from two IoT devices (Ring doorbell and Ring spotlight) could be delayed, due to devices on sleep mode. No device malfunctioned during the experiment. The evaluation also used a test case generator, based on the characteristics of the real data collected. In addition to delayed device events, the evaluation added scenarios where up to two devices malfunctioned during part of the time.

The evaluation calls these data synthetic data, and denote them by synth where no devices malfunctioned, and by synth-MF where up to two devices malfunctioned during part of the time.

The evaluation ran E2AP and IoTMosaic on both the real data and the synthetic data. Let [symbol] denote the input sequence of device events, let [symbol] denote the input sequence of user activities, let w denote the weight vector computed, let [symbol] denote the sequence of activity patterns computed, let [symbol] denote the sequence of device events by the concatenation of the elements of [symbol] , and let [symbol] denote the sequence of user activities computed. For IoTMosaic, the experiment measured the number of undetected user activities (denoted by FN), the number of falsely detected user activities (denoted by FP), and the accuracy. For E2AP, the experiment measured the edit distance between [symbol] and [symbol] (denoted by d(E)), the edit distance between [symbol] and [symbol] (denoted by d(A)), the number of undetected user activities (denoted by FN), the number of falsely detected user activities (denoted by FP), and the accuracy. Since d(E) and d(A) tend to increase as the lengths of the sequences increase, IoT learning framework 165 may utilize d_{N}(E)=d (E)/| [symbol] | and d_{N}(A)=d (A)/| [symbol] | as a form of normalization.

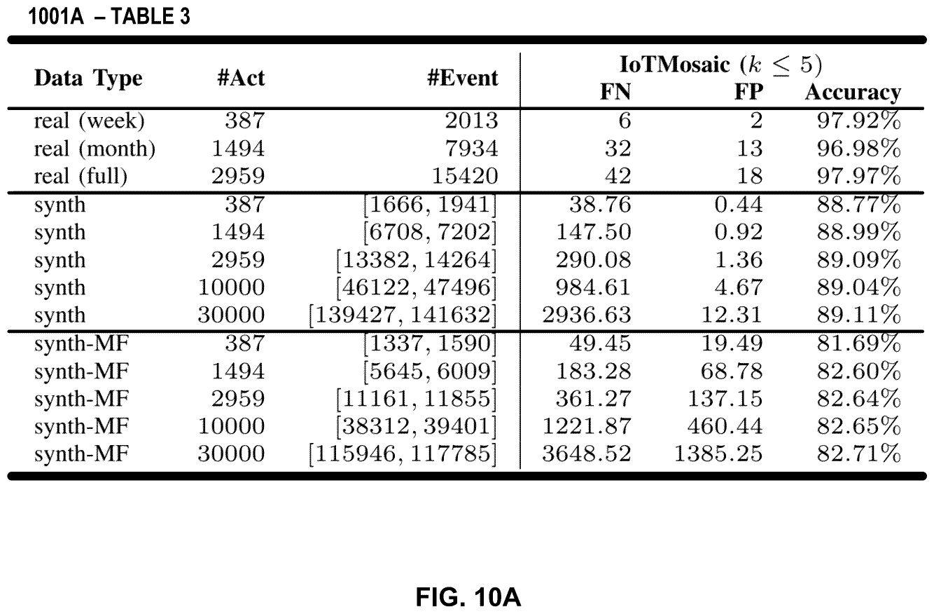

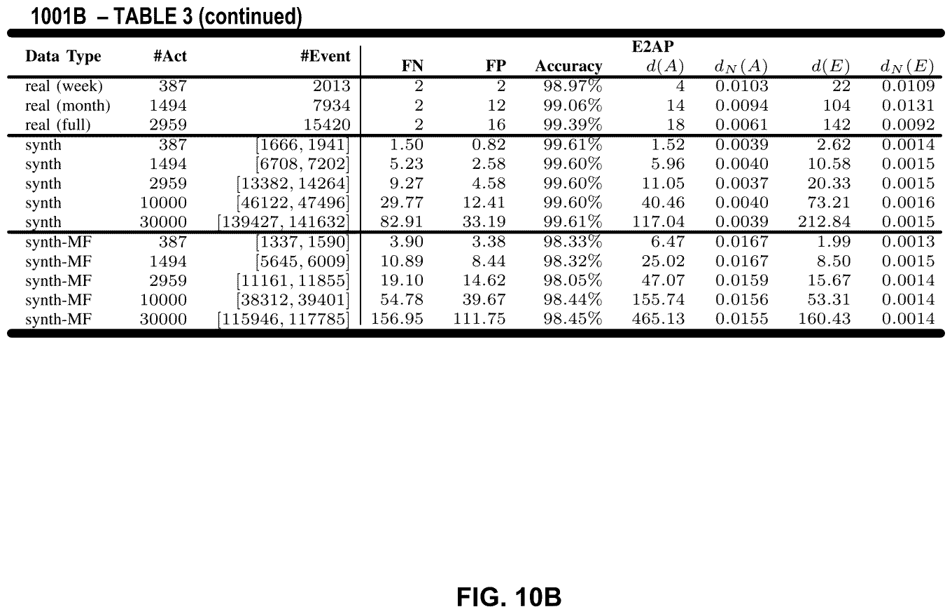

FIGS. 10A and 10B set forth Table 3A at elements 1001A and 1001B, depicting results on real data, with one case per row, and further depicting synthetic data, as an average over 100 cases per row, in accordance with aspects of the disclosure.

### Evaluation Results and Observations:

Table 3 (elements 1001A and 1001B) provides the evaluation results. For each of the three sizes for real data (first week, first month, two months), the corresponding entries in the table are the results of a single run of the denoted algorithm. For each of the five sizes for synth and synth-MF, the evaluation generated 100 test cases. These 100 test cases have the same number of user activities, but have different sequences of user activities (as these are randomly generated), hence having a different number of device events (as the device events are triggered by different user activities). Each entry for #Event shows the minimum and maximum numbers of events (over 100 test cases). All other entries are the average over 100 test cases. The evaluation observed that E2AP has a higher accuracy than IoTMosaic and exhibits more stability.

The evaluations show that both IoTMosaic and E2AP are quite accurate. However, E2AP is consistently more accurate than IoTMosaic. For the 100 test cases without device malfunctions, the accuracies of E2AP fall in the interval [99.09%, 99.97%] with a mean of 99.63% and a standard deviation of 0.0016, compared to that of IoTMosaic in the interval [87.28%, 90.78%] with a mean of 89.09% and a standard deviation of 0.0063. For the 100 test cases with device malfunctions, the accuracies of E2AP fall in the interval [97.70%, 99.02%] with a mean of 98.41% and a standard deviation of 0.0030, compared to that of IoTMosaic in the interval [80.11%, 85.31%] with a mean of 82.65% and a standard deviation of 0.0103. The advantage of E2AP over IoTMosaic is more significant over the combined 200 test cases.

The accuracies of E2AP fall in the interval [97.70%, 99.97%] with a mean of 99.02% and a standard deviation of 0.0066, compared to that of IoTMosaic in the interval [80.11%, 90.78%] with a mean of 85.87% and a standard deviation of 0.0333. The evaluations observe that E2AP is 15% more accurate than IoTMosaic and 5 times more stable than IoTMosaic.

As described above, IoTMosaic gives higher priorities to exact matches of a signature over partial matches of a signature. When a device malfunctions, events corresponding to this malfunctioned device will not appear in the observed sequence of device events. Therefore, in the presence of malfunctioning devices, a user activity may only trigger a subsequence of its full signature. Therefore the number of exact matches will be reduced. This is the root cause for the lower accuracy and higher instability of IoTMosaic. In contrast, E2AP can intelligently adapt to such situations by learning the proper weights for all possible patterns.

More experiments were conducted with different synthetic datasets, and found that the results are consistent with those presented in Table 3 (see FIGS. 10A and 10B) and the chart provided at FIG. 9. E2AP is consistently accurate and stable across different experiment scenarios and varying test cases. Conversely, the accuracy of IoTMosaic decreases when the number of missing events increases, which conforms to the analysis above.

In such a way, the problem of inferring a sequence of user activities together with their patterns from a sequence of device events in a smart home setting is described and resolved. The novel two-phase scheme for solving this problem was specially designed and implemented with the notable extension of the described unsupervised learning algorithm which helps make the inference more adaptive to varying scenarios. No existing algorithm can be directly applied to minimize the non-differentiable and non-convex loss function for the problem.

Still further, the specially designed novel algorithm for minimizing the loss function over one variable is provided herein, which is a central component in the unsupervised learning algorithm. Extensive evaluations show that the algorithm is significantly more robust and accurate than the state-of-the-art algorithm. Further extensions may include, for instance, evaluating the limitations of the scheme in more smart homes as well as exploring its applications in home security. Another possible extension is to explore other machine learning techniques to solve this problem.

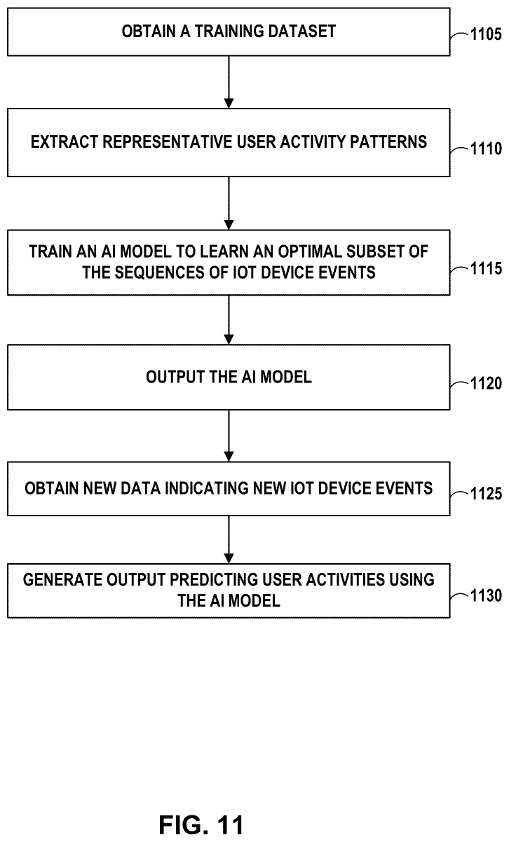

FIG. 11 is a flow chart illustrating an example mode of operation for computing device 100 to infer user activities from Internet of Things (IoT) connected device events using machine learning based algorithms, in accordance with aspects of the disclosure. The mode of operation is described with respect to computing device 100 and FIGS. 1, 2, 3A, 3B, 3C, 4A, 4B, 5, 6, 7A, 7B, 7C, 8, 9, 10A, and 10B.

Computing device 100 may obtain a training dataset (1105). For instance, processing circuitry may execute an Internet-of-Things (IoT) learning framework (IoT learning framework) to train an AI model. In such an example, processing circuitry may obtain, using the IoT learning framework, a training dataset indicating at least sequences of IoT device events.

Computing device 100 may Extract representative user activity patterns (1110). For example, processing circuitry 199 of computing device 100 may extract, using the IoT learning framework, representative user activity patterns from the sequences of IoT device events indicated by the training dataset.

Computing device 100 may train an AI model to learn an optimal subset of the sequences of IoT device events (1115). For example, processing circuitry 199 of computing device 100 may train, using the IoT learning framework, the AI model to learn an optimal subset of the sequences of IoT device events corresponding to a smallest quantity of the sequences of IoT device events to predict user activities with accuracy that satisfies a threshold.

Computing device 100 may output the ai model (1120).

Computing device 100 may obtain new data indicating new IoT device events (1125). For example, processing circuitry 199 of computing device 100 may obtain, using the IoT learning framework, new data indicating new sequences of IoT device events not indicated by the training dataset.

Computing device 100 may generate output predicting user activities using the AI model (1130). For example, processing circuitry 199 of computing device 100 may generate, using the AI model, output indicating one or more user activities predicted by the AI model to have occurred based on the new sequences of IoT device events.

According to another example, computing device 100 may deterministically extract, using the AI model, representative user activity patterns from the sequences of IoT device events indicated by the training dataset. According to such an example, computing device 100 may train, using the IoT learning framework, the AI model using the representative user activity patterns.

According to another example, computing device 100 may deterministically extract, using the AI model, device events from a plurality of connected IoT devices based on the plurality of connected IoT devices each generating a repeatable sequence of network packets represented within the training dataset. According to such an example, computing device 100 may train, using the IoT learning framework, the AI model using the device events extracted.

According to another example, computing device 100 may apply, using the AI model, unsupervised learning to the user activity patterns to learn network weights for the IoT learning framework.

According to another example, computing device 100 may apply, using the IoT learning framework, a loss function to adapt the AI model to device malfunctions indicated within the training dataset.

According to another example, computing device 100 may generate, using the AI model, the output indicating the one or more user activities predicted by the AI model to have occurred based on the new sequences of IoT device events satisfying the smallest quantity of the sequences of IoT device events to predict the user activities.

According to another example, computing device 100 may generate, using the AI model, the output indicating the one or more user activities predicted by the AI model to have occurred based on the new data satisfying a match for a repeatable sequence of network packets identified within the training dataset.

For processes, apparatuses, and other examples or illustrations described herein, including in any flowcharts or flow diagrams, certain operations, acts, steps, or events included in any of the techniques described herein may be performed in a different sequence, may be added, merged, or left out altogether (e.g., not all described acts or events are necessary for the practice of the techniques). Moreover, in certain examples, operations, acts, steps, or events may be performed concurrently, e.g., through multi-threaded processing, interrupt processing, or multiple processors, rather than sequentially. Certain operations, acts, steps, or events may be performed automatically even if not specifically identified as being performed automatically. Also, certain operations, acts, steps, or events described as being performed automatically may be alternatively not performed automatically, but rather, such operations, acts, steps, or events may be, in some examples, performed in response to input or another event.

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

In accordance with the examples of this disclosure, the term “or” may be interrupted as “and/or” where context does not dictate otherwise. Additionally, while phrases such as “one or more” or “at least one” or the like may have been used in some instances but not others; those instances where such language was not used may be interpreted to have such a meaning implied where context does not dictate otherwise.

In one or more examples, the functions described may be implemented in hardware, software, firmware, or any combination thereof. If implemented in software, the functions may be stored, as one or more instructions or code, on and/or transmitted over a computer-readable medium and executed by a hardware-based processing unit. Computer-readable media may include computer-readable storage media, which corresponds to a tangible medium such as data storage media, or communication media including any medium that facilitates transfer of a computer program from one place to another (e.g., pursuant to a communication protocol). In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may include RAM, ROM, EEPROM, CD-ROM or other optical disk storage, magnetic disk storage, or other magnetic storage devices, flash memory, or any other medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the terms “processor” or “processing circuitry” as used herein may each refer to any of the foregoing structures or any other structure suitable for implementation of the techniques described. In addition, in some examples, the functionality described may be provided within dedicated hardware and/or software modules. Also, the techniques could be fully implemented in one or more circuits or logic elements.

What is claimed is:

1. A system comprising:
processing circuitry; and
non-transitory computer readable media storing instructions that, when executed by the processing circuitry, configure the processing circuitry to:
execute, by the processing circuitry, an Internet-of-Things (IoT) learning framework (IoT learning framework) to train an AI model;
obtain, by the processing circuitry using the IoT learning framework, a training dataset indicating at least sequences of IoT device events;
extract, by the processing circuitry using the IoT learning framework, representative user activity patterns from the sequences of IoT device events indicated by the training dataset;
train, by the processing circuitry using the IoT learning framework, the AI model to learn an optimal subset of the sequences of IoT device events corresponding to a smallest quantity of the sequences of IoT device events to predict user activities with accuracy that satisfies a threshold;
output, by the processing circuitry using the IoT learning framework, the AI model;
obtain, by the processing circuitry using the IoT learning framework, new data indicating new sequences of IoT device events not indicated by the training dataset; and
generate, by the processing circuitry using the AI model, output indicating one or more user activities predicted by the AI model to have occurred based on the new sequences of IoT device events.

2. The system of claim 1, wherein the processing circuitry is further configured to:
deterministically extract, by the processing circuitry using the AI model, representative user activity patterns from the sequences of IoT device events indicated by the training dataset; and
train, by the processing circuitry using the IoT learning framework, the AI model using the representative user activity patterns.

3. The system of claim 1, wherein the processing circuitry is further configured to:
deterministically extract, by the processing circuitry using the AI model, device events from a plurality of connected IoT devices based on the plurality of connected IoT devices each generating a repeatable sequence of network packets represented within the training dataset; and
train, by the processing circuitry using the IoT learning framework, the AI model using the device events extracted.

4. The system of claim 1, wherein the processing circuitry is further configured to:
apply, by the processing circuitry using the AI model, unsupervised learning to the user activity patterns to learn network weights for the IoT learning framework.

5. The system of claim 1, wherein the processing circuitry is further configured to:
apply, by the processing circuitry using the IoT learning framework, a loss function to adapt the AI model to device malfunctions indicated within the training dataset.

6. The system of claim 1, wherein the processing circuitry is further configured to:
generate, by the processing circuitry using the AI model, the output indicating the one or more user activities predicted by the AI model to have occurred based on the new sequences of IoT device events satisfying the smallest quantity of the sequences of IoT device events to predict the user activities.

7. The system of claim 6, wherein the processing circuitry is further configured to:
generate, by the processing circuitry using the AI model, the output indicating the one or more user activities predicted by the AI model to have occurred based on the new data satisfying a match for a repeatable sequence of network packets identified within the training dataset.

8. A method comprising:
executing, by one or more processors of a computing device, an Internet-of-Things (IoT) learning framework (IoT learning framework) to train an AI model;
obtaining, by the one or more processors using the IoT learning framework, a training dataset indicating at least sequences of IoT device events;
extracting, by the one or more processors using the IoT learning framework, representative user activity patterns from the sequences of IoT device events indicated by the training dataset;
training, by the one or more processors using the IoT learning framework, the AI model to learn an optimal subset of the sequences of IoT device events corresponding to a smallest quantity of the sequences of IoT device events to predict user activities with accuracy that satisfies a threshold;
outputting, by the one or more processors using the IoT learning framework, the AI model;
obtaining, by the one or more processors using the IoT learning framework, new data indicating new sequences of IoT device events not indicated by the training dataset; and
generating, by the one or more processors using the AI model, output indicating one or more user activities predicted by the AI model to have occurred based on the new sequences of IoT device events.

9. The method of claim 8, further comprising:
deterministically extracting, by the one or more processors using the AI model, representative user activity patterns from the sequences of IoT device events indicated by the training dataset; and
training, by the one or more processors using the IoT learning framework, the AI model using the representative user activity patterns.

10. The method of claim 8, further comprising:
deterministically extracting, by the one or more processors using the AI model, device events from a plurality of connected IoT devices based on the plurality of connected IoT devices each generating a repeatable sequence of network packets represented within the training dataset; and
training, by the one or more processors using the IoT learning framework, the AI model using the device events extracted.

11. The method of claim 8, further comprising:
applying, by the one or more processors using the AI model, unsupervised learning to the user activity patterns to learn network weights for the IoT learning framework.

12. The method of claim 8, further comprising:
applying, by the one or more processors using the IoT learning framework, a loss function to adapt the AI model to device malfunctions indicated within the training dataset.

13. The method of claim 8, further comprising:
generating, by the one or more processors using the AI model, the output indicating the one or more user activities predicted by the AI model to have occurred based on the new sequences of IoT device events satisfying the smallest quantity of the sequences of IoT device events to predict the user activities.

14. The method of claim 13, further comprising:
generating, by the one or more processors using the AI model, the output indicating the one or more user activities predicted by the AI model to have occurred based on the new data satisfying a match for a repeatable sequence of network packets identified within the training dataset.

15. Computer-readable storage media storing instructions that, when executed, configure processing circuitry to:
execute an Internet-of-Things (IoT) learning framework (IoT learning framework) to train an AI model;
obtain, using the IoT learning framework, a training dataset indicating at least sequences of IoT device events;
extract, using the IoT learning framework, representative user activity patterns from the sequences of IoT device events indicated by the training dataset;
train, using the IoT learning framework, the AI model to learn an optimal subset of the sequences of IoT device events corresponding to a smallest quantity of the sequences of IoT device events to predict user activities with accuracy that satisfies a threshold;
output, using the IoT learning framework, the AI model;
obtain, using the IoT learning framework, new data indicating new sequences of IoT device events not indicated by the training dataset; and
generate, using the AI model, output indicating one or more user activities predicted by the AI model to have occurred based on the new sequences of IoT device events.

16. The computer-readable storage media comprising of claim 15, wherein the processing circuitry is further configured to:
deterministically extract, using the AI model, representative user activity patterns from the sequences of IoT device events indicated by the training dataset; and
train, using the IoT learning framework, the AI model using the representative user activity patterns.

17. The computer-readable storage media comprising of claim 15, wherein the processing circuitry is further configured to:
deterministically extract, using the AI model, device events from a plurality of connected IoT devices based on the plurality of connected IoT devices each generating a repeatable sequence of network packets represented within the training dataset; and
train, using the IoT learning framework, the AI model using the device events extracted.

18. The computer-readable storage media comprising of claim 15, wherein the processing circuitry is further configured to:
apply, using the AI model, unsupervised learning to the user activity patterns to learn network weights for the IoT learning framework.

19. The computer-readable storage media comprising of claim 15, wherein the processing circuitry is further configured to:
apply, using the IoT learning framework, a loss function to adapt the AI model to device malfunctions indicated within the training dataset.

20. The computer-readable storage media comprising of claim 15, wherein the processing circuitry is further configured to:
generate, using the AI model, the output indicating the one or more user activities predicted by the AI model to have occurred based on the new sequences of IoT device events satisfying the smallest quantity of the sequences of IoT device events to predict the user activities; and
generate, using the AI model, the output indicating the one or more user activities predicted by the AI model to have occurred based on the new data satisfying a match for a repeatable sequence of network packets identified within the training dataset.
